(19) United States
(12) Patent Application Publication
(10) Pub. No.: US 2024/0089652 A1
(43) Pub. Date: Mar. 14, 2024

(54) APPARATUS

(71) Applicant: LG DISPLAY CO., LTD., Seoul (KR)

(72) Inventor: Sungtae LEE, Paju-si (KR)

(73) Assignee: LG DISPLAY CO., LTD., SEOUL (KR)

(21) Appl. No.: 18/239,298

(22) Filed: Aug. 29, 2023

(30) Foreign Application Priority Data
Sep. 5, 2022 (KR) 10-2022-0112333

(51) Int. Cl. H04R 1/28; H04R 1/02; H04R 17/00

(52) U.S. Cl. CPC H04R 1/2807; H04R 1/025; H04R 1/028; H04R 17/005; H04R 2201/029

(57) ABSTRACT

An apparatus includes a vibration member, a vibration apparatus configured to vibrate the vibration member, a supporting member at a rear surface of the vibration member, an enclosure at a rear surface of the supporting member overlapping with the vibration apparatus, and a porous member between the rear surface of the supporting member and the enclosure.

### CROSS-REFERENCE TO RELATED APPLICATION

This application claims the priority of Korean Patent Application No. 10-2022-0112333 filed on Sep. 5, 2022, which is hereby incorporated by reference in its entirety.

### BACKGROUND

### Field of the Disclosure

The present disclosure relates to an apparatus.

### Description of the Background

An apparatus includes a separate speaker or sound apparatus for providing sound. When a speaker is provided in the apparatus, a problem may occur where the design and the space arrangement of the apparatus are limited due to a space occupied by the speaker.

However, because a sound output from the speaker of the display apparatus may travel to a rearward or a downward direction of the display apparatus, sound quality may be degraded due to interference between sounds reflected from a wall and the ground. For this reason, it may be difficult to transfer accurate sound, and the immersion experience of a viewer can be reduced.

### SUMMARY

Accordingly, the present disclosure is directed to an apparatus that substantially obviates one or more of problems due to limitations and disadvantages described above.

More specifically, the present disclosure is to provide an apparatus which can enhance the quality of sound and a sound pressure level characteristic.

An aspect of the present disclosure is directed to providing an apparatus which may vibrate a vibration member to generate a vibration or a sound and may enhance a sound characteristic and/or a sound pressure level characteristic.

Another aspect of the present disclosure is directed to providing an apparatus which may vibrate a vibration member to generate a vibration or a sound and may enhance a sound characteristic and/or a sound pressure level characteristic of a low-pitched sound band.

Additional advantages, aspects, and features of the disclosure are set forth in part in the present disclosure and will also be apparent from the present disclosure or may be learned by practice of the inventive concepts provided herein. Other features, advantages, and aspects of the present disclosure may be realized and attained by the structure particularly pointed out in the present disclosure, or derivable therefrom, and claims hereof as well as the appended drawings.

To achieve these and other advantages and aspects of the present disclosure, as embodied and broadly described, an apparatus includes a vibration member and a vibration apparatus configured to vibrate the vibration member. A supporting member may be at a rear surface of the vibration member. An enclosure may be at a rear surface of the supporting member overlapping with the vibration apparatus. The apparatus may include a porous member between the rear surface of the supporting member and the enclosure.

In another aspect of the present disclosure, an apparatus includes a vibration member, a vibration apparatus disposed on the vibration member and causing the vibration member to vibrate, a supporting member facing the vibration member, a sound accommodating area between the vibration member and the supporting member, and an airflow facilitating part including a sound accommodating material and disposed on a surface of the supporting member facing opposite to the vibration apparatus.

An apparatus according to an aspect of the present disclosure may include a vibration apparatus vibrating a vibration member or a display panel, and thus, may generate a sound so that the sound travels in a forward direction of the vibration member or the display panel.

An apparatus according to an aspect of the present disclosure may include an enclosure where a porous member, including a plurality of pores formed in a rear surface of a supporting member connected or communicating with an internal space provided between the supporting member and a vibration member, is disposed, and thus, an air resistance of the internal space may decrease, thereby enhancing a vibration characteristic of the vibration member and outputting a sound where a sound pressure level characteristic and/or a sound characteristic of a low-pitched sound band are/is enhanced.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with aspects of the disclosure.

It is to be understood that both the foregoing description and the following description of the present disclosure are exemplary and explanatory and are intended to provide further explanation of the disclosures as claimed.

### BRIEF DESCRIPTION OF THE DRAWINGS

The accompanying drawings, which are included to provide a further understanding of the disclosure, are incorporated in and constitute a part of this disclosure, illustrate aspects and aspects of the disclosure and together with the description serve to explain the principles of the disclosure.

In the drawings:

FIG. 1 illustrates an apparatus according to an aspect of the present disclosure;

FIG. 2 is a cross-sectional view taken along line I-I′ illustrated in FIG. 1 according to an aspect of the present disclosure;

FIG. 3 illustrates a vibration apparatus according to an aspect of the present disclosure;

FIG. 4 illustrates a vibration apparatus according to an aspect of the present disclosure;

FIG. 5 illustrates a vibration apparatus according to another aspect of the present disclosure;

FIG. 6 is another cross-sectional view taken along line I-I′ illustrated in FIG. 1 according to another aspect of the present disclosure;

FIG. 7 illustrates a vibration apparatus according to another aspect of the present disclosure;

FIG. 8 illustrates a vibration apparatus according to another aspect of the present disclosure;

FIG. 9 illustrates a vibration apparatus according to another aspect of the present disclosure;

FIG. 10 is a cross-sectional view taken along line II-IF illustrated in FIG. 9 according to another aspect of the present disclosure;

FIG. 11 illustrates a vibration part illustrated in FIG. 10 according to another aspect of the present disclosure;

FIG. 12 illustrates another aspect of the vibration part illustrated in FIG. 10 according to another aspect of the present disclosure;

FIG. 13 illustrates another aspect of the vibration part illustrated in FIG. 10 according to another aspect of the present disclosure; and

FIG. 14 illustrates another aspect of the vibration part illustrated in FIG. 10 according to another aspect of the present disclosure;

### DETAILED DESCRIPTION

Reference is now made in detail to aspects of the present disclosure, examples of which may be illustrated in the accompanying drawings. In the following description, where a detailed description of relevant known functions or configurations may unnecessarily obscure aspects of the present disclosure, a detailed description of such known functions or configurations may be omitted for brevity. The progression of processing steps and/or operations described is an example, and the sequence of steps and/or operations is not limited to that set forth herein and may be changed, with the exception of steps and/or operations necessarily occurring in a particular order.

Throughout the drawings and the detailed description, unless otherwise described, the same drawing reference numerals should be understood to refer to the same elements, features, or structures. The sizes, lengths, and thicknesses of layers, regions and elements, and depiction of thereof may be exaggerated for clarity, illustration, and convenience.

Advantages and features of the present disclosure, and implementation methods thereof will be clarified through the aspects described with reference to the accompanying drawings. The present disclosure may, however, be embodied in different forms and should not be construed as limited to the aspects set forth herein. Rather, these aspects are examples and are provided so that this disclosure may be thorough and complete to assist those skilled in the art to understand the inventive concepts without limiting the protected scope of the present disclosure.

The shapes, dimensions, areas, ratios, angles, numbers, and the like disclosed in the drawings for describing aspects of the present disclosure are merely an example, and thus, the present disclosure is not limited to the illustrated details. Like reference numerals are refer to like elements throughout.

Where the term “comprise,” “have,” “include,” “contain,” “constitute,” “made up of,” “formed of” or the like is used, one or more other elements may be added unless a term such as “only” or the like is used. The terms used in the present disclosure are merely used to describe particular aspects, and are not intended to limit the scope of the present disclosure. The terms of a singular form may include plural forms unless the context clearly indicates otherwise.

The word “exemplary” is used to mean serving as an example or illustration, unless otherwise specified. Aspects are example aspects. Aspects are example aspects. Any implementation described herein as an “example” is not necessarily to be construed as preferred or advantageous over other implementations.

In one or more aspects, an element, feature, or corresponding information (e. g., a level, range, dimension, size, or the like) is construed as including an error or tolerance range even where no explicit description of such an error or tolerance range is provided. An error or tolerance range may be caused by various factors (e. g., process factors, internal or external impact, noise, or the like). Further, the term “may” encompasses all the meanings of the term “may.”

In describing a positional relationship where the positional between two parts relationship is described, for example, using “on,” “over,” “under,” “above,” “below,” “beneath,” “near,” “close to,” “adjacent to,” “beside,” “next to,” “on a side of” or the like, one or more parts may be located between two parts unless a more limiting term, such as “immediate(ly),” “direct(ly),” or “close(ly),” is used. For example, where a structure is described as being positioned “on,” “over,” “under,” “above,” “below,” “beneath,” “near,” “close to,” “adjacent to,” “beside,” “next to” or “on a side of” another structure, this description should be construed as including a case in which the structures contact each other as well as a case in which one or more additional structures are disposed or interposed therebetween. Furthermore, the terms “front,” “rear,” “back,” “left,” “right,” “top,” “bottom,” “downward,” “upward,” “upper,” “lower,” “up,” “down,” “column,” “row,” “vertical,” “horizontal,” and the like refer to an arbitrary frame of reference.

In describing a temporal relationship, where the temporal order is described as, for example, “after,” “subsequent,” “next,” “before,” “preceding,” “prior to,” or the like, a case that is not consecutive or not sequential may be included unless a more limiting term, such as “just,” “immediate(ly),” or “direct(ly),” is used.

It will be understood that, although the terms “first”, “second,” or the like may be used herein to describe various elements, these elements should not be limited by these terms, for example, to any particular order, precedence, or number of elements. These terms are only used to partition one element from another. For example, a first element could be termed a second element, and, similarly, a second element could be termed a first element, without departing from the scope of the present disclosure. Furthermore, the first element, the second element, and the like may be arbitrarily named according to the convenience of those skilled in the art without departing from the scope of the present disclosure. The terms “first,” “second,” and the like may be used to distinguish components from each other, but the functions or structures of the components are not limited by ordinal numbers or component names in front of the components.

In describing elements of the present disclosure, the terms “first,” “second,” “A,” “B,” “(a),” “(b),” or the like may be used. These terms are intended to identify the corresponding element(s) from the other element(s), and these are not used to define the essence, basis, order, or number of the elements.

For the expression that an element or layer is described as “connected,” “coupled,” “attached,” or “adhered” to another element or layer, the element or layer may not only be directly connected, coupled, attached, or adhered to another element or layer, but also be indirectly connected, coupled, attached, or adhered to another element or layer with one or more intervening elements or layers disposed or interposed between the elements or layers, unless otherwise specified.

For the expression that an element or layer “contacts,” “overlap with,” or the like with another element or layer, the element or layer may not only directly contact, overlap with, or the like with another element or layer, but also indirectly contact, overlap with, or the like with another element or layer with one or more intervening elements or layers disposed or interposed between the elements or layers, unless otherwise specified.

The terms such as a “line” or “direction” should not be interpreted only based on a geometrical relationship in which the respective lines or directions are parallel or perpendicular to each other. Such terms may mean a wider range of lines or directions within which the components of the present disclosure may operate functionally.

The term “at least one” should be understood as including any and all combinations of one or more of the associated listed items. For example, the meaning of “at least one of a first item, a second item, and a third item” encompasses the combination of all three listed items, combinations of any two the first item, the second item, and the third item as well as any individual item, the first item, the second item, or the third item.

The expression of a first element, a second elements, “and/or” a third element should be understood to encompass one of the first, second, and third elements, as well as any and all combinations of the first, second and third elements. By way of example, A, B and/or C encompass only A; only B; only C; any combination of two of A, B, and C; and all of A, B, and C. Furthermore, an expression “element A/element B” may be understood as element A and/or element B.

In one or more aspects, the terms “between” and “among” may be used interchangeably simply for convenience unless stated otherwise. For example, an expression “between a plurality of elements” may be understood as among a plurality of elements. In another example, an expression “among a plurality of elements” may be understood as between a plurality of elements. In one or more examples, the number of elements may be two. In one or more examples, the number of elements may be more than two.

In one or more aspects, the phrases “each other” and “one another” may be used interchangeably simply for convenience unless stated otherwise. For example, an expression “different from each other” may be understood as different from one another. In another example, an expression “different from one another” may be understood as different from each other. In one or more examples, the number of elements involved in the foregoing expression may be two. In one or more examples, the number of elements involved in the foregoing expression may be more than two.

In one or more aspects, the phrases “one or more among” and “one or more of” may be used interchangeably simply for convenience unless stated otherwise.

In the present disclosure, examples of an apparatus may include a narrow-sense display apparatus such as an organic light emitting display (OLED) module or a liquid crystal module (LCM) including a display panel and a driver for driving the display panel. Also, examples of the display apparatus may include a set device (or a set apparatus) or a set electronic apparatus such as a notebook computer, a TV, a computer monitor, an equipment apparatus including an automotive apparatus or another type apparatus for vehicles, or a mobile electronic device such as a smartphone or an electronic pad, which is a complete product (or a final product) including an LCM or an OLED module.

Therefore, in the present disclosure, examples of the apparatus may include a narrow-sense display apparatus itself, such as an LCM or an OLED module, and a set device which is a final consumer device or an application product including the LCM or the OLED module.

In some aspects, an LCM or an OLED module including a display panel and a driver may be referred to as a narrow-sense display apparatus, and an electronic apparatus which is a final product including an LCM or an OLED module may be referred to as a set apparatus. For example, the narrow-sense display apparatus may include a display panel, such as an LCD or an OLED, and a source printed circuit board (PCB) which is a controller for driving the display panel. The set apparatus may further include a set PCB which is a set controller electrically connected to the source PCB to overall control the set apparatus.

A display panel applied to the present aspect may use all types of display panels such as a liquid crystal display panel, an organic light emitting diode (OLED) display panel, and an electroluminescent display panel, but aspects of the present disclosure are not limited to a specific display panel, which is vibrated by a sound generation device according to the present aspect to output a sound. Also, a shape or a size of a display panel applied to a display apparatus according to the present aspect is not limited.

For example, when the display panel is the liquid crystal display panel, the display panel may include a plurality of gate lines, a plurality of data lines, and a plurality of pixels respectively provided in a plurality of pixel areas defined by intersections of the gate lines and the data lines. Also, the display panel may include an array substrate including a thin film transistor (TFT) which is a switching element for adjusting a light transmittance of each of the plurality of pixels, an upper substrate including a color filter and/or a black matrix, and a liquid crystal layer between the array substrate and the upper substrate.

Moreover, when the display panel is the organic light emitting display panel, the display panel may include a plurality of gate lines, a plurality of data lines, and a plurality of pixels respectively provided in a plurality of pixel areas defined by intersections of the gate lines and the data lines. Also, the display panel may include an array substrate including a TFT which is an element for selectively applying a voltage to each of the pixels, an organic light emitting device layer on the array substrate, and an encapsulation substrate disposed at the array substrate to cover the organic light emitting device layer. The encapsulation substrate may protect the TFT and the organic light emitting device layer from an external impact and may prevent water or oxygen from penetrating into the organic light emitting device layer. Also, a layer provided on the array substrate may include an inorganic light emitting layer (for example, a nano-sized material layer, a quantum dot, or the like). As another aspect of the present disclosure, the layer provided on the array substrate may include a micro light emitting diode.

The display panel may further include a backing such as a metal plate attached on the display panel. However, aspects of the present disclosure art not limited to the metal plate, and the display panel may include another structure.

Features of various aspects of the present disclosure may be partially or wholly coupled to or combined with each other, and may be operated, linked, or driven together in various ways. Aspects of the present disclosure may be carried out independently from each other, or may be carried out together in a co-dependent or related relationship. In one or more aspects, the components of each apparatus according to various aspects of the present disclosure may be operatively coupled and configured.

Unless otherwise defined, the terms (including technical and scientific terms) used herein have the same meaning as commonly understood by one of ordinary skill in the art to which example aspects belong. It should be further understood that terms, such as those defined in commonly used dictionaries, should be interpreted as having a meaning that is, for example, consistent with their meaning in the context of the relevant art and should not be interpreted in an idealized or overly formal sense, unless expressly defined otherwise herein.

In the following description, various example aspects of the present disclosure are described in detail with reference to the accompanying drawings. With respect to reference numerals to elements of each of the drawings, the same elements may be illustrated in other drawings, and like reference numerals may refer to like elements unless stated otherwise. In addition, for convenience of description, a scale, dimension, size, and thickness of each of the elements illustrated in the accompanying drawings may be different from an actual scale, dimension, size, and thickness. Thus, aspects of the present disclosure are not limited to a scale, dimension, size, or thickness illustrated in the drawings.

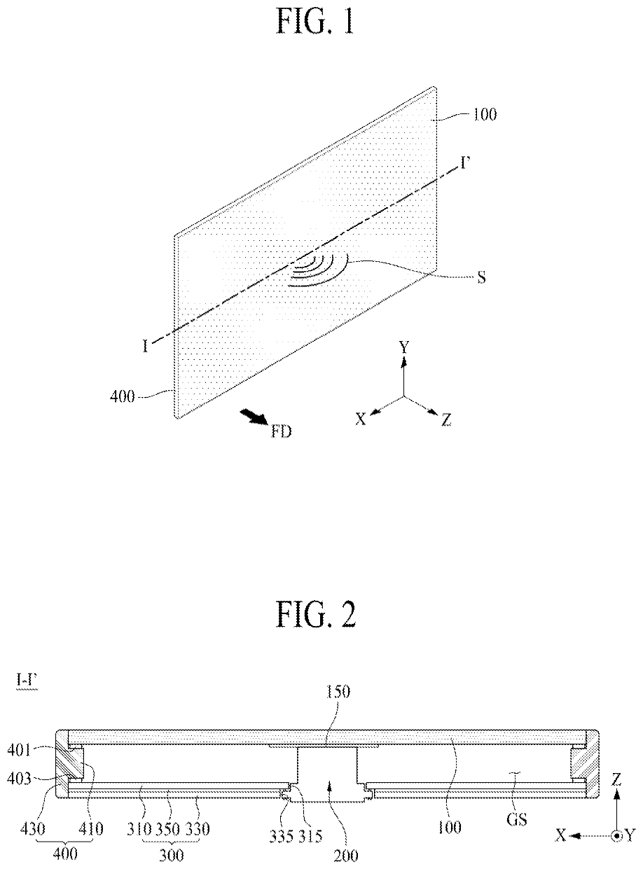

FIG. 1 illustrates an apparatus according to an aspect of the present disclosure, and FIG. 2 is a cross-sectional view taken along line I-I′ illustrated in FIG. 1.

With reference to FIGS. 1 and 2, the apparatus according to an aspect of the present disclosure may include a vibration member 100 and a vibration apparatus 200 disposed at a rear surface (or a backside) of the vibration member 100 or connected with the rear surface of the vibration member 100 to vibrate the vibration member 100. For example, the vibration member 100 may be a vibration object, a display panel, a vibration plate, or a front member, but aspects of the present disclosure are not limited thereto. Hereinafter, an example where a vibration member is a display panel will be described.

The vibration member 100 according to an aspect of the present disclosure may be a display panel displaying an image. The display panel may display an electronic image, a digital image, a still image or a video image. For example, the display panel may output light to display an image. The display panel may be a curved display panel, or may be any type of display panel, such as a liquid crystal display panel, an organic light-emitting display panel, a quantum dot light-emitting display panel, a micro light-emitting diode display panel, and an electrophoresis display panel. The display panel may be a flexible display panel. For example, the display panel may be a flexible light emitting display panel, a flexible electrophoretic display panel, a flexible electro-wetting display panel, a flexible micro light emitting diode display panel, or a flexible quantum dot light emitting display panel, but aspects of the present disclosure are not limited thereto.

The display panel according to an aspect of the present disclosure may include a display area (or an active area) for displaying an image according to driving of the plurality of pixels. The display panel may include a non-display area (or an inactive area or a non-active area) surrounding the display area, but aspects of the present disclosure are not limited thereto.

The display panel according to an aspect of the present disclosure may include an anode electrode, a cathode electrode, and a light emitting device, and may be configured to display an image in a type such as a top emission type, a bottom emission type, or a dual emission type, according to a structure of a pixel array layer including a plurality of pixels. In the top emission type, an image may be displayed by outputting visible light generated from the pixel array layer to the forward region of a base substrate. In the bottom emission type, an image may be displayed by outputting visible light generated from the pixel array layer to the backward region of the base substrate.

The display panel according to an aspect of the present disclosure may include a pixel array part disposed at the substrate. The pixel array part may include a plurality of pixels which display an image based on a signal supplied through the signal lines. The signal lines may include a gate line, a data line, and a pixel driving power line, or the like, but aspects of the present disclosure are not limited thereto.

Each of the plurality of pixels may include a pixel circuit layer including a driving thin film transistor (TFT) provided at the pixel area which is configured by a plurality of gate lines and/or a plurality of data lines, an anode electrode electrically connected to the driving TFT, a light emitting layer formed over the anode electrode, and a cathode electrode electrically connected to the light emitting layer.

The driving TFT may be configured at a transistor region of each pixel area provided at a substrate. The driving TFT may include a gate electrode, a gate insulation layer, a semiconductor layer, a source electrode, and a drain electrode. The semiconductor layer of the driving TFT may include silicon such as amorphous silicon (a-Si), polysilicon (poly-Si), or low temperature poly-Si, or may include oxide such as indium-gallium-zinc-oxide (IGZO), but aspects of the present disclosure are not limited thereto.

The anode electrode may be provided at an opening region provided at each pixel area and may be electrically connected to the driving TFT.

A light emitting device according to an aspect of the present disclosure may include an organic light emitting device layer formed over an anode electrode. The organic light emitting device layer may be implemented to emit light having the same color (for example, white light) for each pixel, or may be implemented to emit light having a different color (for example, red light, green light, or blue light) for each pixel. A cathode electrode (or a common electrode) may be connected to the organic light emitting device layer provided in each pixel area in common. For example, the organic light emitting device layer may have a single structure or a stack structure including two or more structures including the same color for each pixel. As another aspect of the present disclosure, the organic light emitting device layer may have a stack structure including two or more structures including one or more different colors for each pixel. The two or more structures including the one or more different colors may be configured with one or more of blue, red, yellow-green, and green or a combination thereof, but aspects of the present disclosure are not limited thereto. An example of the combination may include blue and red, red and yellow-green, red and green, red/yellow-green/green, or the like, but aspects of the present disclosure are not limited thereto. Also, regardless of a stack order thereof, aspects of the present disclosure may be applied. The stack structure including two or more structures having the same color or one or more different colors may further include a charge generating layer between the two or more structures. The charge generating layer may have a PN junction structure and may include an N-type charge generating layer and a P-type charge generating layer.

According to another aspect of the present disclosure, the light emitting device may include a micro light emitting diode device electrically connected to each of an anode electrode and a cathode electrode. The micro light emitting diode device may be a light emitting diode implemented as an integrated circuit (IC) or chip type. The micro light emitting diode device may include a first terminal electrically connected to the anode electrode and a second terminal electrically connected to the cathode electrode. The cathode electrode may be connected to the second terminal of the micro light emitting diode device provided in each pixel area in common.

An encapsulation part may be formed on the substrate to surround the pixel array part, thereby preventing oxygen or water from penetrating into the light emitting device layer of the pixel array part. The encapsulation part according to an aspect of the present disclosure may be formed in a multi-layer structure where an organic material layer and an inorganic material layer are alternately stacked, but the term is not limited thereto. The inorganic material layer may prevent oxygen or water from penetrating into the light emitting device layer of the pixel array part. The organic material layer may be formed to have a thickness which is relatively thicker than the inorganic material layer, to cover particles occurring in a manufacturing process. For example, the encapsulation part may include a first inorganic layer, an organic layer on the first inorganic layer, and a second inorganic layer on the organic layer. The organic layer may be a particle cover layer. The touch panel may be disposed at the encapsulation part, or may be disposed at a rear surface of the pixel array part.

The display panel according to an aspect of the present disclosure may include a first substrate, a second substrate, and a liquid crystal layer. The first substrate may be an upper substrate or a thin film transistor (TFT) array substrate. For example, the first substrate may include a pixel array (or a display part or a display area) including a plurality of pixels which are respectively provided in a plurality of pixel areas defined by intersections between a plurality of gate lines and/or a plurality of data lines. Each of the plurality of pixels may include a TFT connected to a gate line and/or a data line, a pixel electrode connected to the TFT, and a common electrode which is provided adjacent to the pixel electrode and is supplied with a common voltage.

The first substrate may further include a pad part provided at a first periphery (or a first non-display part) and a gate driving circuit provided at a second periphery (or a second non-display part).

The pad part may supply a signal, supplied from the outside, to the pixel array and/or the gate driving circuit. For example, the pad part may include a plurality of data pads connected to a plurality of data lines through a plurality of data link lines and/or a plurality of gate input pads connected to the gate driving circuit through a gate control signal line. For example, a size of the first substrate may be greater than the second substrate, but aspects of the present disclosure are not limited thereto.

The gate driving circuit (or a scan driving circuit) according to an aspect of the present disclosure may be embedded (or integrated) into a second periphery of the first substrate to be connected to the plurality of gate lines. For example, the gate driving circuit may be implemented with a shift register including a transistor, which is formed by the same process as the TFT provided at the pixel area. According to another aspect of the present disclosure, the gate driving circuit may be implemented as an integrated circuit (IC) and may be provided at a panel driving circuit, without being embedded into the first substrate.

The second substrate may be a lower substrate or a color filter array substrate. For example, the second substrate may include a pixel pattern (or a pixel defining pattern or a black matrix) including an opening area overlapping with the pixel area formed in the first substrate, and a color filter layer formed at the opening area. The second substrate may have a size which is smaller than the first substrate, but aspects of the present disclosure are not limited thereto. For example, the second substrate may overlap with a remaining portion, other than the first periphery, of the upper substrate. The second substrate may be attached to a remaining portion, other than the first periphery, of the first substrate with a liquid crystal layer therebetween by a sealant.

The liquid crystal layer may be disposed between the first substrate and the second substrate. The liquid crystal layer may include a liquid crystal including liquid crystal molecules where an alignment direction thereof is changed based on an electric field generated by the common voltage and a data voltage applied to a pixel electrode for each pixel.

A second polarization member may be attached on a bottom surface of the second substrate and may polarize light which is incident from the backlight and travels to the liquid crystal layer. A first polarization member may be attached on a top surface (or an upper surface) of the first substrate and may polarize light which passes through the first substrate and is output to the outside.

The display panel according to an aspect of the present disclosure may drive the liquid crystal layer based on an electric field which is generated in each pixel by the data voltage and the common voltage applied to each pixel, and thus, may display an image based on light passing through the liquid crystal layer.

In display panel according to another aspect of the present disclosure, the first substrate may be implemented as the color filter array substrate, and the second substrate may be implemented as the TFT array substrate. For example, the display panel according to another aspect of the present disclosure may have a type where an upper portion and a lower portion of the display panel according to an aspect of the present disclosure are reversed therebetween. For example, a pad part of the display panel according to another aspect of the present disclosure may be covered by a separate mechanism or structure.

The display panel according to an aspect of the present disclosure may include a bending part that may be bent or curved to have a curved shape or a certain curvature radius.

The bending part of the display panel may be in at least one or more of one periphery and the other periphery of the display panel, which are parallel to each other. The one periphery and/or the other periphery, where the bending part is implemented, of the display panel may include only the non-display area, or may include a periphery of the display area and the non-display area. The display panel including the bending part implemented by bending of the non-display area may have a one-side bezel bending structure or a both-side bezel bending structure. Also, the display panel including the bending part implemented by bending of the periphery of the display area and the non-display area may have a one-side active bending structure or a both-side active bending structure.

According to another aspect of the present disclosure, the vibration member 100 may include one or more of metal, wood, rubber, plastic, carbon, glass, cloth, fiber, paper, mirror, and leather, but aspects of the present disclosure are not limited thereto. For example, the paper may be a cone paper for speakers. For example, the cone paper may be pulp or foam plastic, but aspects of the present disclosure are not limited thereto.

According to another aspect of the present disclosure, the vibration member 100 may include one or more of a display panel including a pixel displaying an image, a screen panel on which an image is to be projected from a display apparatus, a lighting panel, a signage panel, a vehicular (or car or automotive or transporting) interior material, a vehicular glass window, a vehicular exterior material, a ceiling material of a vehicular, a ceiling material of a building, an interior material of a building, a glass window of a building, and mirror, but aspects of the present disclosure are not limited thereto. For example, the display panel may be a curved display panel or all types of display panels such as a liquid crystal display panel, an organic light emitting display panel, a quantum dot light emitting display panel, a micro light emitting diode display panel, and an electrophoresis display panel. For example, the display panel may be a flexible display panel. For example, the flexible display panel may be a flexible light emitting display panel, a flexible electrophoresis display panel, a flexible electro-wetting display panel, a flexible micro light emitting diode display panel, or a flexible quantum dot light emitting display panel, but aspects of the present disclosure are not limited thereto. For example, a lighting panel (or a non-display panel) may be a light emitting diode lighting panel (or apparatus), an organic light emitting diode lighting panel (or apparatus), or an inorganic light emitting diode lighting panel (or apparatus), but aspects of the present disclosure are not limited thereto.

The vibration apparatus 200 may vibrate the vibration member 100. For example, the vibration apparatus 200 may be implemented at a rear surface of the vibration member 100. For example, the vibration apparatus 200 may vibrate the vibration member 100 at the rear surface of the vibration member 100, and thus, may provide a user with a sound S and/or a haptic feedback, based on a vibration of the vibration member 100. For example, the vibration member 100 may output the sound S, based on a vibration of the vibration apparatus 200. The vibration apparatus 200 may output the sound S by the vibration member 100 as a vibration plate. For example, the vibration apparatus 200 may output the sound S in a forward (or front) direction FD) of the vibration member 100 by the vibration member 100 as a vibration plate. For example, the vibration apparatus 200 may generate the sound S so that the sound travels in a forward (or front) direction FD of the display panel or the vibration member 100. The vibration apparatus 200 may vibrate the vibration member 100 to output the sound S. For example, the vibration apparatus 200 may directly vibrate the vibration member 100 to output the sound S in the forward (or front) direction FD of the apparatus.

According to an aspect of the present disclosure, the vibration apparatus 200 may vibrate based on a vibration driving signal synchronized with an image displayed by the display panel corresponding to the vibration member 100 to vibrate the display panel. According to an aspect of the present disclosure, the vibration apparatus 200 may vibrate based on a haptic feedback signal (or a tactile feedback signal) synchronized with a user touch applied to a touch panel (or a touch sensor layer) disposed in or embedded into the display panel 100 to vibrate the display panel. Accordingly, the display panel may vibrate based on a vibration of the vibration apparatus 200 to provide a user (or a viewer) with at least one of the sound S and the haptic feedback.

The vibration apparatus 200 according to an aspect of the present disclosure may pass through the supporting member 300 and may contact the rear surface of the vibration member 100, and thus, may directly vibrate the vibration member 100. For example, an upper portion of the vibration apparatus 200 may be inserted (or accommodated) into through holes 315 and 335 (or a first hole) provided in the supporting member 300 and may be connected with the rear surface of the vibration member 100, and a lower portion of the vibration apparatus 200 may be supported by (or fixed to) the supporting member 300. For example, the vibration apparatus 200 may vibrate by the supporting member 300 as a supporter to vibrate the vibration member 100, and the vibration member 100 may output the sound S in the forward direction FD. For example, the vibration apparatus 200 may be a transducer, an actuator, or an exciter, but the terms are not limited thereto.

The apparatus according to an aspect of the present disclosure may further include a heat dissipation member 150 which is disposed at the rear surface of the vibration member 100.

The heat dissipation member 150 may be disposed between the vibration member 100 and the vibration apparatus 200. The heat dissipation member 150 may be provided between the vibration member 100 and the vibration apparatus 200 and may reduce or decrease heat occurring in the vibration apparatus 200. For example, the heat dissipation member 150 may prevent or minimize the transfer of heat, occurring in the vibration apparatus 200, to the vibration member 100. The heat dissipation member 150 may limit the local temperature rising of the vibration member 100 caused by heat occurring in the vibration apparatus 200. For example, the heat dissipation member 150 may prevent or minimize the transfer of heat, occurring in the vibration apparatus 200, to the display panel which is the vibration member 100. In this case, the heat dissipation member 150 may limit the temperature rising of the display panel or the vibration member 100 caused by heat which occurs due to an operation of the vibration apparatus 200 when the display panel or the vibration member 100 outputs a sound, and thus, may prevent an image quality defect of the display panel or the vibration member 100 from occurring due to a rapid temperature difference in a local region of the display panel or the vibration member 100 overlapping with the vibration apparatus 200.

According to an aspect of the present disclosure, the heat dissipation member 150 may be disposed on the rear surface of the display panel or the vibration member 100 by an adhesive member. The heat dissipation member 150 may be configured to cover the vibration apparatus 200 or to have a size which is greater than that of the vibration apparatus 200. The heat dissipation member 150 may have a polygonal plate shape or a circular plate shape having a certain thickness, but aspects of the present disclosure are not limited thereto. For example, the heat dissipation member 150 may be a heat dissipation sheet or a heat dissipation tape including a metal material, having high heat conductivity, such as aluminum (Al), copper (Cu), or silver (Ag) or an alloy thereof, but aspects of the present disclosure are not limited thereto. Accordingly, because the apparatus according to an aspect of the present disclosure further includes the heat dissipation member 150, an adverse effect of heat occurring when the vibration apparatus 200 is vibrating may be reduced on the display panel or the vibration member 100 or the image quality of the display panel.

The apparatus according to an aspect of the present disclosure may further include a supporting member 300 which is disposed at a rear surface (or a backside surface) of the vibration member 100.

The supporting member 300 may be disposed at the rear surface of the vibration member 100 or the display panel. For example, the supporting member 300 may cover the rear surface of the vibration member 100 or the display panel. For example, the supporting member 300 may cover the entire rear surface of the vibration member 100 or the display panel with a gap space GS (or a first space) therebetween. The supporting member 300 may be spaced apart from a rearmost surface of the vibration member 100 or the display panel with the gap space GS therebetween, or may be spaced apart from the vibration apparatus 200. For example, the gap space GS may be referred to as a first space, an internal space, an air gap, a vibration space, or a sound sounding box, but the terms are not limited thereto.

For example, the supporting member 300 may include one or more materials of a glass material, a metal material, and a plastic material. For example, the supporting member 300 may be a rear structure, a set structure, a supporting structure, a supporting cover, a rear member, a case, or a housing, but the terms are not limited thereto. The supporting member 300 may be referred to as the other term such as a cover bottom, a plate bottom, a back cover, a base frame, a metal frame, a metal chassis, a chassis base, or an m-chassis. For example, the supporting member 300 may be implemented as an arbitrary type frame or a plate structure each disposed at the rear surface of the vibration member 100.

An edge or a sharp corner of the supporting member 300 may have an inclined shape or a curved shape through a chamfer process or a corner rounding process. For example, the glass material of the supporting member 300 may include sapphire glass. In another aspect of the present disclosure, the supporting member 300 including the metal material may include one or more materials of aluminum (Al), an Al alloy, magnesium (Mg), a Mg alloy, and an iron (Fe)-nickel (Ni) alloy.

The supporting member 300 according to an aspect of the present disclosure may include the through holes 315 and 335 (or the first hole) into which the vibration apparatus 200 is inserted (or accommodated). For example, the through holes 315 and 335 may be punched to have a circular or polygonal shape in a predetermined partial region of the supporting member 300 in a thickness direction Z of the supporting member 300, so that the vibration apparatus 200 is inserted (or accommodated) in the through holes 315 and 335.

According to an aspect of the present disclosure, the through holes 315 and 335 (or the first hole) may be provided for decreasing an air pressure of the gap space GS (or the first space) between the vibration member 100 and the supporting member 300. For example, the through holes 315 and 335 may provide a path into which the vibration apparatus 200 may be inserted (or accommodated) and may provide a path which enables the gap space GS between the vibration member 100 and the supporting member 300 to be connected or communicate with the outside. In this case, the vibration apparatus 200 may include an air penetration hole (or a second hole) which is formed in a portion overlapping with the through holes 315 and 335. For example, the air penetration hole of the vibration apparatus 200 may be formed to pass through or vertically pass through a portion, overlapping with each of the through holes 315 and 335, of the vibration apparatus 200. Therefore, the gap space GS between the vibration member 100 and the supporting member 300 or an inner portion of the vibration apparatus 200 may be connected or communicate with the outside by the through holes 315 and 335 of the supporting member 300 and the air penetration hole of the vibration apparatus 200, and thus, an air pressure of the gap space GS between the vibration member 100 and the supporting member 300 or an air pressure of the inner portion of the vibration apparatus 200 may be reduced.

The supporting member 300 according to an aspect of the present disclosure may include a first supporting member 310 and a second supporting member 330.

The first supporting member 310 may be disposed between the second supporting member 330 and the rear surface of the vibration member 100 or the display panel. For example, the first supporting member 310 may be disposed between a rear edge (or a rear periphery) of the vibration member 100 or the display panel and a front edge portion (or a front periphery portion) of the second supporting member 330. The first supporting member 310 may support one or more of an edge portion (or a periphery portion) of the vibration member 100 or the display panel and an edge portion (or a periphery portion) of the second supporting member 330. In another aspect of the present disclosure, the first supporting member 310 may cover the rear surface of the vibration member 100 or the display panel. For example, the first supporting member 310 may cover the entire rear surface of the vibration member 100 or the display panel. For example, the first supporting member 310 may be a member which covers the entire rear surface of the vibration member 100 or the display panel. For example, the first supporting member 310 may include one or more materials of a glass material, a metal material, and a plastic material. For example, the first supporting member 310 may be an inner plate, a first rear structure, a first supporting structure, a first supporting cover, a first back cover, a first rear member, an internal plate, or an internal cover, but the terms are not limited thereto. For example, the first supporting member 310 may be omitted.

The first supporting member 310 may be spaced apart from a rearmost surface of the vibration member 100 with the gap space GS (or a first space) therebetween. The first supporting member 310 may support or fix the vibration apparatus 200. For example, the gap space GS may be referred to as a first space, an internal space, an inner space, an air gap, a vibration space, or a sound sounding box, but the terms are not limited thereto.

The second supporting member 330 may be disposed at a rear surface of the first supporting member 310. The second supporting member 330 may be a member which covers the entire rear surface of the vibration member 100 or the display panel. For example, the second supporting member 330 may include one or more materials of a glass material, a metal material, and a plastic material. For example, the second supporting member 330 may be an outer plate, a rear plate, a back plate, a back cover, a rear cover, a second rear structure, a second supporting structure, a second supporting cover, a second back cover, a second rear member, an external plate, or an external cover, but the terms are not limited thereto.

According to an aspect of the present disclosure, the first supporting member 310 and the second supporting member 330 may each include through holes 315 and 335 (or a first hole) into which the vibration apparatus 200 is inserted (or accommodated). For example, the through holes 315 and 335 may be punched to have a circular or polygonal shape in a predetermined partial region of each of the first supporting member 310 and the second supporting member 330 in a thickness direction Z of the first supporting member 310 and the second supporting member 330, so that the vibration apparatus 200 is inserted (or accommodated) in the through holes 315 and 335. For example, the first supporting member 310 may include a first through hole 315, and the second supporting member 330 may include a second through hole 335. For example, the first through hole 315 of the first supporting member 310 may have the same size as that of the second through hole 335 of the second supporting member 330, or may have a size which is less than that of the second through hole 335 of the second supporting member 330. For example, the first through hole 315 of the first supporting member 310 may have a size which is less than that of the second through hole 335 of the second supporting member 330, and a portion of the rear surface of the first supporting member 310 may be exposed through the second through hole 335 of the second supporting member 330. In this case, the vibration apparatus 200 may be fixed to the rear surface of the first supporting member 310 exposed by the second through hole 335 of the second supporting member 330. For example, an upper portion (or one side or one portion) of the vibration apparatus 200 may pass through the through holes 315 and 335 of the first supporting member 310 and the second supporting member 330 and may contact the rear surface of the vibration member 100, and a lower portion (or the other side or the other portion) of the vibration apparatus 200 may be fixed to the rear surface of the first supporting member 310 exposed by the second through hole 335 of the second supporting member 330.

According to an aspect of the present disclosure, the first supporting member 310 and the second supporting member 330 may include different materials. For example, the first supporting member 310 may include a metal material such as an aluminum (Al) material which is good in heat conductivity, and the second supporting member 330 may include a glass material, but aspects of the present disclosure are not limited thereto.

According to an aspect of the present disclosure, the first supporting member 310 and the second supporting member 330 may have the same thickness or different thicknesses. For example, the first supporting member 310 may have a thickness which is relatively thinner than the second supporting member 330, but aspects of the present disclosure are not limited thereto.

The supporting member 300 according to an aspect of the present disclosure may further include a connection member 350.

The connection member 350 may be disposed between the first supporting member 310 and the second supporting member 330. For example, the first supporting member 310 and the second supporting member 330 may be coupled to or connected with each other by the connection member 350. For example, the connection member 350 may be an adhesive resin, a double-sided tape, or a double-sided adhesive foam pad, but aspects of the present disclosure are not limited thereto. For example, the connection member 350 may have elasticity for absorbing an impact, but aspects of the present disclosure are not limited thereto. For example, the connection member 350 may be disposed in an entire region between the first supporting member 310 and the second supporting member 350. According to another aspect of the present disclosure, the connection member 350 may be formed in a mesh structure having an air gap between the first supporting member 310 and the second supporting member 330.

The apparatus according to an aspect of the present disclosure may further include a middle frame 400. The middle frame 400 may be disposed between a rear edge (or a rear periphery) of the vibration member 100 or the display panel and a front edge (or a front periphery) of the supporting member 300. The middle frame 400 may support one or more of an edge portion (or a periphery portion) of the vibration member 100 or the display panel and an edge portion (or a periphery portion) of the supporting member 300. The middle frame 400 may surround one or more of lateral surfaces of each of the vibration member 100 or the display panel and the supporting member 300. The middle frame 400 may provide a gap space GS between the vibration member 100 or the display panel and the supporting member 300. The middle frame 400 may be referred to as a middle cabinet, a middle cover, a middle chassis, a connection member, a frame, a frame member, a middle member, or a side cover member, but the terms are not limited thereto.

The middle frame 400 according to an aspect of the present disclosure may include a first supporting part 410 and a second supporting portion 430. For example, the first supporting part 410 may be a supporting part, but the terms are not limited thereto. For example, the second supporting part 430 may be a sidewall part, but the terms are not limited thereto.

The first supporting part 410 may be disposed between the rear edge (or the rear periphery) of the vibration member 100 or the display panel and the front edge (or the front periphery) of the supporting member 300, and thus, may provide a gap space GS between the vibration member 100 or the display panel and the supporting member 300. A front surface of the first supporting part 410 may be coupled to or connected with the rear edge portion (or the rear periphery portion) of the vibration member 100 or the display panel by a first adhesive member 401. A rear surface of the first supporting part 410 may be coupled to the front edge (or the front periphery) of the supporting member 300 by a second adhesive member 403. For example, the first supporting part 410 may have a single tetragonal picture frame structure, or may include a picture frame structure having a plurality of division bar shapes, but aspects of the present disclosure are not limited thereto.

The second supporting part 430 may be arranged in parallel with the thickness direction Z of the apparatus. For example, the second supporting part 430 may be vertically coupled to an outer surface of the first supporting part 410 in parallel with the thickness direction Z of the apparatus. The second supporting part 430 may surround one or more of an outer surface of the vibration member 100 and an outer surface of the supporting member 300, thereby protecting the outer surface of each of the vibration member 100 and the supporting member 300. The first supporting part 410 may protrude from an inner surface of the second supporting part 430 to the gap space GS between the vibration member 100 and the supporting member 300.

The apparatus according to an aspect of the present disclosure may include a panel connection member (or a connection member) instead of the middle frame 400.

The panel connection member may be disposed between a rear edge portion (or a rear periphery portion) of the vibration member 100 and a front edge portion (or a front periphery portion) of the supporting member 300, and thus, may provide the gap space GS between the vibration member 100 and the supporting member 300. For example, the panel connection member may be implemented as a double-sided tape, a single-sided tape, or a double-sided adhesive foam pad, but aspects of the present disclosure are not limited thereto. For example, an adhesive layer of the panel connection member may include epoxy, acrylic, silicone, or urethane, but aspects of the present disclosure are not limited thereto. For example, the adhesive layer of the panel connection member may include a urethane-based material (or substance) having a relatively ductile characteristic compared to acryl-based material, to minimize the transfer of a vibration of the vibration member 100 to the supporting member 300. Accordingly, a vibration of the vibration member 100 transferred to the supporting member 300 may be minimized.

In the apparatus according to an aspect of the present disclosure, when the apparatus includes the panel connection member instead of the middle frame 400, the supporting member 300 may include a bending sidewall which is bent from one side (or an end or one portion) of the second supporting member 330 and surrounds one or more of outer surfaces (or outer sidewalls) of the first supporting member 310, the panel connection member, and the vibration member 100. The bending sidewall according to an aspect of the present disclosure may have a single sidewall structure or a hemming structure. The hemming structure may include a structure where ends of an arbitrary member is bent in a curved shape to overlap with each other, or are spaced apart from each other in parallel. For example, to enhance a sense of beauty in design, the bending sidewall may include a first bending sidewall, which is bent from one side (or an end or one portion) of the second supporting member 330, and a second bending sidewall which is bent from the first bending sidewall to a region between the first bending sidewall and the outer surface of the vibration member 100. The second bending sidewall may be spaced apart from an inner surface of the first bending sidewall, to decrease the transfer of an external impact to the outer surface of the vibration member 100 in a lateral direction or a contact between the outer surface of the vibration member 100 and the inner surface of the first bending sidewall. Accordingly, the second bending sidewall may decrease the transfer of the external impact to the outer surface of the vibration member 100 in the lateral direction or a contact between the outer surface of the vibration member 100 and the inner surface of the first bending sidewall.

According to another aspect of the present disclosure, the middle frame 400 may be omitted in the apparatus according to an aspect of the present disclosure. The panel connection member or an adhesive may be provided instead of the middle frame 400. According to another aspect of the present disclosure, a partition may be provided instead of the middle frame 400.

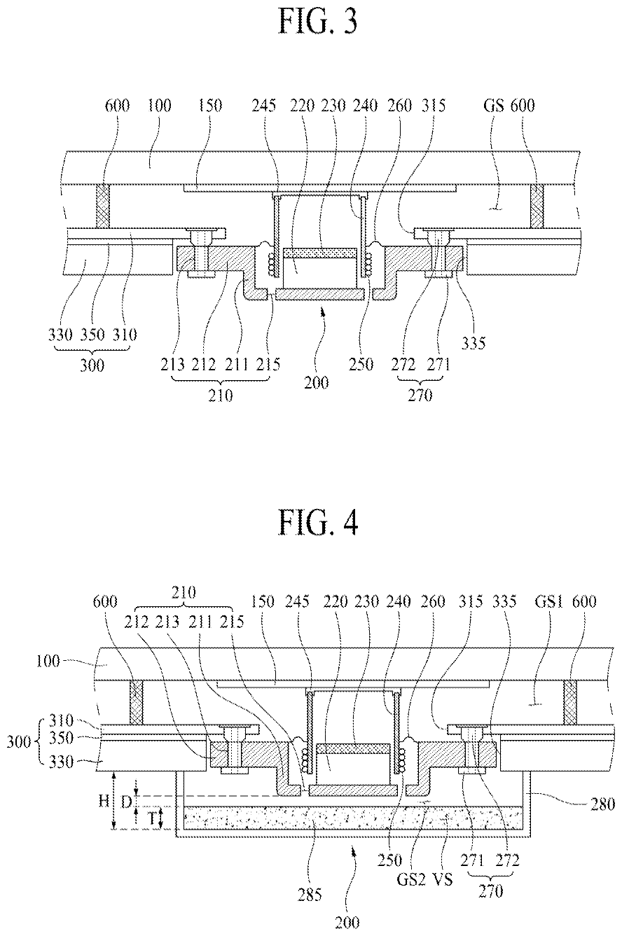

FIG. 3 illustrates a vibration apparatus 200 according to an aspect of the present disclosure.

Referring to FIG. 3, the vibration apparatus 200 according to an aspect of the present disclosure may include a frame 210, a magnet 220, a center pole 230, a bobbin 240 around the magnet 220, and a coil 250 around the bobbin 240.

The frame 210 may be fixed to a supporting member 300 to overlap with through holes 315 and 335 (or a first hole) of the supporting member 300 and may support the magnet 220. The frame 210 may accommodate the magnet 220, the center pole 230, the bobbin 240, and the coil 250. For example, the magnet 220 may be disposed on the frame 210. For example, the center pole 230 may be disposed on the frame 210. For example, the frame 210 may include a first frame, accommodating the magnet 220, the center pole 230, the bobbin 240, and the coil 250, and a second frame 212 which protrudes from an edge (or a periphery) of the first frame 211. The first frame 211 and the second frame 212 may be provided as one body. For example, the first frame 211 and the second frame 212 may include a material such as iron (Fe), but aspects of the present disclosure are not limited thereto. The first frame 211 and the second frame 212 may be referred to the other terms such as a yoke, but the terms are not limited thereto.

The first frame 211 may accommodate the magnet 220, the center pole 230, the bobbin 240, and the coil 250. For example, an inner portion of the first frame 211 may have a circular pillar shape, an oval pillar shape, or a cylindrical shape. The magnet 220 may be disposed on the first frame 211, and the center pole 230 may be disposed on the magnet 220. The first frame 211 may support the magnet 220 and the center pole 230. The first frame 211 may be provided to surround the magnet 220 and the center pole 230 on the first frame 211 and the bobbin 240 and the coil 250 disposed around the center pole 230. For example, the coil 250 may be wound around an outer portion of the bobbin 240.

According to an aspect of the present disclosure, the first frame 211 may further include at least one air penetration hole 215 (or second hole).

The at least one air penetration hole 215 (or second hole) may provide a path which enables an inner portion of the first frame 211, into which the bobbin 240 and the coil 250 are accommodated, to be connected or communicate with the outside. For example, the at least one air penetration hole 215 may be formed to pass through or vertically pass through the first frame 211. The at least one air penetration hole 215 (or second hole) may be formed in a portion, overlapping with each of the through holes 315 and 335 (or first hole), of the supporting member 300. For example, the at least one air penetration hole 215 may be formed to pass through or vertically pass through the first frame 211 overlapping with the through holes 315 and 335 of the supporting member 300. Therefore, the gap space GS (or first space) between the vibration member 100 and the supporting member 300 or the inner portion of the first frame 211 may connect or communicate with the outside by the through holes 315 and 335 of the supporting member 300. For example, the at least one air penetration hole 215 may connect or communicate the gap space GS between the vibration member 100 and the supporting member 300 with the outside by the through holes 315 and 335 of the supporting member 300.

The at least one air penetration hole 215 (or second hole) may be configured to discharge heat, occurring in the bobbin 240 and the coil 250 accommodated into the first frame 211, to the outside. The at least one air penetration hole 215 may be provided in a portion overlapping with the bobbin 240 and the coil 250 accommodated into the first frame 211. For example, the at least one air penetration hole 215 may be formed to pass through or vertically pass through the portion overlapping with the bobbin 240 and the coil 250. The at least one air penetration holes 215 may be arranged at a certain interval (or distance). For example, the at least one air penetration holes 215 may be arranged at a certain interval (or distance) in a circumference direction of the bobbin 240 and the coil 250 accommodated into the first frame 211. A size (or diameter) of each of the at least one air penetration holes 215 may be greater than or equal to a thickness of the bobbin 240 and the coil 250. However, aspects of the present disclosure are not limited to the shape or arrangement of the at least one air penetration holes 215.

The second frame 212 may be formed to protrude from an edge (or a periphery) of the first frame 211. The second frame 212 may be provided as one body with the first frame 211. For example, the second frame 212 may have a ring shape which surrounds the first frame 211. A coupling portion 213 fixed to the supporting member 300 may be formed at a portion of the second frame 212. The second frame 212 may be coupled or fixed to the supporting member 300 by the connection member 270 fastened to the coupling portion 213. For example, the connection member 270 may include a screw 271 and a nut 272. The nut 272 of the connection member 270 may be fixed to the supporting member 300. For example, the nut 272 may be fixed to the first supporting member 310. A portion of a rear surface of the first supporting member 310 may be exposed through a second through hole 335 of the second supporting member 330, and the nut 272 may be fixed to the rear surface of the first supporting member 310 exposed through the second through hole 335 of the second supporting member 330. The screw 271 of the connection member 270 may be fastened to the nut 272 fixed to the first supporting member 310 through the coupling portion 213, and thus, may couple the second frame 212 to the first supporting member 310. For example, the nut 272 may be a self-clinching nut. Accordingly, the vibration apparatus 200 may be fixed to the supporting member 300. For example, the self-clinching nut may be a PEM® nut, but aspects of the present disclosure are not limited thereto.

The magnet 220 may be disposed on the frame 210. For example, the magnet 220 may be disposed on the first frame 211 of the frame 210. A lower end of the magnet 220 may be supported by the first frame 211, and a periphery of the magnet 220 may be surrounded by the first frame 211. The magnet 220 may be disposed at a center of the inner portion of the first frame 211, and the at least one air penetration hole 215 spaced apart from the magnet 220 may be formed in the first frame 211. The at least one air penetration holes 215 may be formed to be spaced apart from one another by a certain interval (or distance) along the periphery of the magnet 220. The at least one air penetration hole 215 may be formed not to overlap with the magnet 220.

The magnet 220 may be a permanent magnet having a ring shape, a cylindrical shape, or an oval shape. The magnet 220 may be implemented with a sintered magnet such as barium ferrite, and a material of the magnet 220 may include one or more of Fe₂O₃, BaCO₃, a neodymium magnet, strontium ferrite (Fe₁₂O₁₉Sr) with improved magnet component, an alloy cast magnet including Al, nickel (Ni), and cobalt (Co). For example, the neodymium magnet may be neodymium-iron-boron (Nd—Fe—B).

The center pole 230 may be disposed on the magnet 220. The center pole 230 may be referred to as pole pieces. In another aspect of the present disclosure, the pole pieces may be further provided on the center pole 230.

The bobbin 240 may surround a periphery of the magnet 220. For example, the bobbin 240 may surround the magnet 220 and the center pole 230. The bobbin 240 may be disposed on the frame 210. For example, the bobbin 240 may be disposed on the first frame 211 of the frame 210. The bobbin 240 may be accommodated into the first frame 211. The bobbin 240 may be surrounded by the first frame 211. For example, the bobbin 240 may be disposed between the magnet 220 and the first frame 211.

The bobbin 240 may be attached on the rear surface of the vibration member 100. The bobbin 240 may be attached on the rear surface of the vibration member 100 by a bobbin ring 245. For example, when a current or a voice signal for generating a sound is applied to the coil 250 wound around an outer circumference surface of the bobbin 240, an entire portion of the bobbin 240 may move upward and downward according to Fleming's left-hand rule based on an applied magnetic field generated around the coil 250 and an external magnetic field generated around the magnet 220. For example, the bobbin 240 may vibrate the vibration member 100 by the bobbin ring 245. Also, the vibration member 100 may receive a vibration from the bobbin 240 or the bobbin ring 245 to generate a sound or a sound wave, and the generated sound or sound wave may be output in a forward direction of the vibration member 100.

The bobbin 240 may include a material through which a magnet flux passes and which is low in heat conductivity. For example, the bobbin 240 may be implemented as a ring-shaped (or cylindrical or oval) structure which includes a material obtained by processing pulp or paper, aluminum (Al), magnesium (Mg), an Al alloy, a Mg alloy, synthetic resin such as polypropylene and polyamide-based fiber, but aspects of the present disclosure are not limited thereto.

The coil 250 may be wound around an outer circumference surface of the bobbin 240. The coil 250 may be wound around the outer circumference surface of the bobbin 240 and may surround the magnet 220 with being spaced apart therefrom. For example, the coil 250 may be wound around the outer circumference surface of the bobbin 240 and may surround the magnet 220 with being spaced apart therefrom, and thus, may be supplied with a current or a voice signal, used to generate a sound, from the outside. The coil 250 may be referred to as a voice coil. For example, the bobbin 240 and the coil 250 may be referred to as a voice coil. The coil 250 may be wound around a certain region of the bobbin 240. For example, the coil 250 may wound around a lower region of the bobbin 240. The coil 250 may be wound around a lower outer circumference surface of the bobbin 240, and the current or the voice signal for generating a sound may be applied from the outside to the coil 250. For example, when the current or the voice signal is applied to the coil 250, the bobbin 240 may be guided according to Fleming's left-hand rule based on an applied magnetic field generated around the coil 250 and a magnetic field generated around the magnet 220 to vibrate. For example, a magnet flux generated by a magnetic field may flow along a closed loop which is connected with the first frame 211, the magnet 220, the center pole 230, and the coil 250. Accordingly, the bobbin 240 may be guided by the damper 260 to vibrate and may transfer a vibration to the vibration member 100.

The damper 260 may be disposed between the first frame 211 and the bobbin 240 and may guide a vibration of the bobbin 240. For example, one end (or one side or one portion) of the damper 260 may be connected with the first frame 211, and the other end (or the other side or the other portion) of the damper 260 may be connected with the bobbin 240. The damper 260 may be provided in a structure which is creased between the one end and the other end thereof, and thus, may be contracted and relaxed based on a vibration of the bobbin 240 and may adjust and guide a vibration of the bobbin 240, based on a rectilinear reciprocating motion. Therefore, the damper 260 may be connected between the first frame 211 and the bobbin 240, and thus, may limit a vibration distance of the bobbin 240 by a restoring force. For example, when the bobbin 240 moves by a certain distance or more or vibrates by a certain distance or less, the bobbin 240 may be restored to an original position with the restoring force of the damper 260. For example, the damper 260 may be referred to as other term such as an edge, a spider, or a suspension, but the terms are not limited thereto.

The bobbin ring 245 may be disposed between the bobbin 240 and the vibration member 100 and may transfer a vibration of the bobbin 240 to the vibration member 100. The bobbin ring 245 may be disposed in an entire of the bobbin 240, but aspects of the present disclosure are not limited thereto, and the bobbin ring 245 may be disposed at a position at which the bobbin 240 is disposed. The bobbin ring 245 may be attached on the rear surface of the vibration member 100 by an adhesive member. For example, the adhesive member may be a double-sided tape, a single-sided tape, an adhesive, or a bond, but aspects of the present disclosure are not limited thereto. For example, the bobbin ring 245 may prevent heat occurring in the bobbin 240 from being transferred to the vibration member 100 and may efficiently transfer a vibration of the bobbin 240 to the vibration member 100.

In the apparatus according to an aspect of the present disclosure, a heat dissipation member 150 may be further provided at the rear surface of the vibration member 100 to decrease or reduce heat occurring when the vibration apparatus 200 is vibrating. For example, the heat dissipation member 150 may be disposed at the rear surface of the vibration member 100 by an adhesive member. For example, the adhesive member may be a double-sided tape, a single-sided tape, an adhesive, or a bond, but aspects of the present disclosure are not limited thereto. The heat dissipation member 150 may be provided to have a size which is greater than that of the vibration apparatus 200 or cover the vibration apparatus 200, but aspects of the present disclosure are not limited thereto. For example, the heat dissipation member 150 may contact the bobbin 240 of the vibration apparatus 200. The heat dissipation member 150 may contact the bobbin ring 245 of the vibration apparatus 200. The heat dissipation member 150 may have a size which is greater than that of the bobbin 240 or the bobbin ring 245 of the vibration apparatus 200 contacting each other. The heat dissipation member 150 may have a polygonal plate shape, a circular plate shape, or an oval plate shape having a constant thickness, but aspects of the present disclosure are not limited thereto. For example, the heat dissipation member 150 may be a heat dissipation sheet or a heat dissipation tape including a metal material, having high heat conductivity, such as aluminum (Al), copper (Cu) and silver (Ag) or an alloy thereof, but aspects of the present disclosure are not limited thereto. Accordingly, because the apparatus according to an aspect of the present disclosure further includes the heat dissipation member 150, an adverse effect of heat occurring when the vibration apparatus 200 is vibrating may be reduced on the display panel or the vibration member 100 or the image quality of the display panel.

For example, the heat dissipation member 150 may be attached on the vibration apparatus 200 by an adhesive member. The adhesive member may be a double-sided tape, a single-sided tape, an adhesive, or a bond, but aspects of the present disclosure are not limited thereto. For example, the adhesive member may be disposed between the heat dissipation member 150 and the bobbin 240 or the bobbin ring 245.

A gap space GS (or a first space) may be provided between the vibration member 100 and the supporting member 300. A partition member 600 providing or defining the gap space GS may be further provided between the vibration member 100 and the supporting member 300.

The partition member 600 may provide or define the gap space GS which generates a sound when the vibration member 100 is vibrated by the vibration apparatus 200. The partition member 600 may separate the sound generated by the vibration member 100, or may separate a channel, and thus, may prevent or decrease interference of the sound. The partition member 600 may be referred to as an enclosure or a baffle, but the terms are not limited thereto.

The partition member 600 may divide or provide a gap space GS (or a first space) corresponding to one vibration apparatus 200. For example, the partition member 600 may be provided to surround a periphery of one vibration apparatus 200. The partition member 600 may include four sides surrounding the vibration apparatus 200. For example, the partition member 600 may be implemented in a structure where the four sides are provided as one body, and thus, may be configured in a structure which seals the gap space GS between the vibration member 100 and the supporting member 300 at a periphery of the vibration apparatus 200. As another example, the partition member 600 may include a plurality of open portions which are provided at one or more of the four sides, and thus, may be configured in a structure which does not seal the gap space GS between the vibration member 100 and the supporting member 300 at the periphery of the vibration apparatus 200.

The gap space GS (or the first space) provided or divided by the partition member 600 may be connected or communicate with the outside of a rear surface of the apparatus by the through holes 315 and 335 of the supporting member 300 and the air penetration hole 215 of the vibration apparatus 200. For example, because the gap space GS provided or divided by the partition member 600 is connected or communicates with the outside of the rear surface of the apparatus by the through holes 315 and 335 of the supporting member 300 and the air penetration hole 215 of the vibration apparatus 200, an air pressure of the gap space GS may decrease. Accordingly, an air pressure of the gap space GS may be reduced by the partition member 600, and thus, an air impedance of the gap space GS may decrease, thereby improving a sound pressure level characteristic and/or a sound characteristic of a low-pitched sound band.

According to an aspect of the present disclosure, the partition member 600 may include a material capable of absorbing a vibration or controlling a vibration. The partition member 600 may include a single-sided tape, a single-sided foam tape, a single-sided foam pad, a double-sided tape, a double-sided foam pad, or a double-sided foam tape, but aspects of the present disclosure are not limited thereto. For example, the partition member 600 may include one or more materials of a silicone-based polymer, paraffin wax, a urethane-based polymer, and an acrylic-based polymer. For example, the partition member 600 may include a urethane-based material (or substance) having a relatively ductile characteristic compared to acrylic-based polymer, to minimize the transfer of a vibration of the vibration member 100 to the supporting member 300.

FIG. 4 illustrates a vibration apparatus according to an aspect of the present disclosure. FIG. 4 illustrates an aspect implemented by modifying a structure of the vibration apparatus illustrated in FIG. 3. Hereinafter, the vibration apparatus will be described with reference to FIG. 4, and descriptions which are the same as or similar to the descriptions of the vibration apparatus of FIG. 3 are omitted or will be briefly given.

Referring to FIG. 4, a vibration apparatus 200 according to an aspect of the present disclosure may be further configured with an enclosure 280 and a porous member 285.

The enclosure 280 (or an outer enclosure or a rear enclosure or a second enclosure) may be at a rear surface of a supporting member 300 and may be configured to overlap with the vibration apparatus 200.

The enclosure 280 may be disposed at the rear surface of the supporting member 300. The enclosure 280 may be provided at the rear surface of the supporting member 300 overlapping with the vibration apparatus 200. For example, the enclosure 280 may be disposed at the rear surface of the supporting member 300 and may be configured to surround a lower portion of the vibration apparatus 200 connected with a vibration member 100 via through holes 315 and 335 (or a first hole) of the supporting member 300. For example, the enclosure 280 may include an internal space GS2 (a second space or a second sound accommodating area) which surrounds the rear surface of the supporting member 300 and the vibration apparatus 200. The enclosure 280 may include a box shape where one side (or one portion or an upper side or an upper portion) of the internal space GS2 is opened, but aspects of the present disclosure are not limited thereto. For example, the through holes 315 and 335 (or the first hole) of the supporting member 300 may be between a gap space GS1 (a first space or a first sound accommodating area) between the vibration member 100 and the supporting member 300 and the internal space GS2 (a second space or a second sound accommodating area) between the rear surface of the supporting member 300 and the enclosure 280. The gap space GS1 between the vibration member 100 and the supporting member 300 may be connected or communicate with the internal space GS2 between the rear surface of the supporting member 300 and the enclosure 280 through the through holes 315 and 335 (or the first hole) of the supporting member 300. For example, the vibration apparatus 200 may include at least one air penetration hole 215 (or a second hole) overlapping with the through holes 315 and 335 (or the first hole) of the supporting member 300. Accordingly, the internal space GS2 of the enclosure 280 may be connected or communicate with the gap space GS1 between the vibration member 100 and the supporting member 300 through the air penetration hole 215 (or the second hole) formed in the vibration apparatus 200 and the through holes 315 and 335 (or the first hole) of the supporting member 300. The air penetration hole 215 (or the second hole) may be accommodated into the at least one through holes 315 and 335 (or the first hole) of the supporting member 300 and connected with the internal space GS2.

According to an aspect of the present disclosure, because the internal space GS2 of the enclosure 280 is connected or communicates with the gap space GS1 between the vibration member 100 and the supporting member 300 through the air penetration hole 215 (or the second hole) formed in the vibration apparatus 200 and the through holes 315 and 335 (or the first hole) of the supporting member 300, a volume of internal air of the gap space GS1 between the vibration member 100 and the supporting member 300 may be further secured. For example, the internal air of the gap space GS1 between the vibration member 100 and the supporting member 300 and internal air of the internal space GS2 of the enclosure 280 may mutually flow therebetween, and thus, a volume of the internal air of the gap space GS1 between the vibration member 100 and the supporting member 300 may increase and an air resistance may be reduced. Accordingly, an air impedance of the gap space GS1 between the vibration member 100 and the supporting member 300 may decrease, and thus, a sound pressure level characteristic and/or a sound characteristic of a low-pitched sound band may be improved.

The enclosure 280 may include one or more materials of a metal material and a nonmetal material (or a complex nonmetal material), but aspects of the present disclosure are not limited thereto. For example, the enclosure 280 may include one or more materials of a metal material, plastic, and wood, but aspects of the present disclosure are not limited thereto. For example, the enclosure 280 may include a metal material based on an aluminum material, or may include plastic or a plastic material based on a styrene material, but aspects of the present disclosure are not limited thereto. For example, the styrene material may be an ABS material. The ABS material may be acrylonitrile, butadiene, and styrene.

According to an aspect of the present disclosure, the enclosure 280 may prevent sound leakage or the occurrence of a reflected sound through the through holes 315 and 335 (or the first hole) of the supporting member 300 and the air penetration hole 215 (or the second hole) of the vibration apparatus 200 and may prevent the penetration of particles from the outside.

The enclosure 280 may be connected with or coupled to the rear surface of the supporting member 300 by a coupling member. For example, the coupling member may be disposed between a front end of an edge (or a periphery) of the enclosure 280 and the rear surface of the supporting member 300, and the enclosure 280 may be connected with or coupled to the rear surface of the supporting member 300 by the coupling member. For example, the coupling member may be a double-sided tape, a single-sided tape, an adhesive, or a bond, but aspects of the present disclosure are not limited thereto.

The apparatus according to an aspect of the present disclosure may include a porous member 285 between the rear surface of the supporting member 300 and the enclosure 280 to accommodate or facilitate more air flows in the internal space G2. The porous member 285 may contact the rear surface of the supporting member 300.

The porous member 285 may be disposed between the rear surface of the supporting member 300 and the enclosure 280. The porous member 285 may be disposed between the rear surface of the supporting member 300 and an inner surface of the enclosure 280. The porous member 285 may be disposed at the inner surface of the enclosure 280. For example, the porous member 285 may be attached on or coupled to the inner surface of the enclosure 280. The porous member 285 may be attached on or coupled to the inner surface of the enclosure 280 by an adhesive member. For example, the adhesive member may be a double-sided tape, a single-sided tape, an adhesive, or a bond, but aspects of the present disclosure are not limited thereto.

The porous member 285, as illustrated in FIG. 4, may be configured to have a constant thickness (or a same thickness) T in the internal space GS2 of the enclosure 280. For example, the porous member 285 may be configured to have the thickness T which is smaller than a height H of the internal space GS2 of the enclosure 280.

For example, the porous member 285 may be configured to have the constant thickness T capable of being spaced apart from the rear surface of the supporting member 300 by a certain interval (or distance) D. The porous member 285 may be configured to have the constant thickness T capable of being spaced apart from a rearmost surface of the supporting member 300 by the certain interval (or distance) D. For example, the rearmost surface of the supporting member 300 may be the rear surface of the vibration apparatus 200 coupled to the supporting member 300. The rear surface of the vibration apparatus 200 may be a rear surface of the frame 210. For example, the rear surface of the vibration apparatus 200 may be a rear surface of a first frame 211 of the frame 210. The porous member 285 may have the constant thickness T capable of being spaced apart from the rear surface of the first frame 211 of the vibration apparatus 200 by the certain interval (or distance) D. For example, the porous member 285 may have the constant thickness T capable of being spaced apart from the rear surface of the first frame 211, where the at least one air penetration hole 215 of the vibration apparatus 200 is disposed, by the certain interval (or distance) D.

The porous member 285 may include a porous material including a plurality of pores provided therein. The porous member 285 may include a porous material having a range where a porosity rate is about 90%. For example, the porous member 285 may include one or more materials of a porous coordination polymer (PCP), a metal organic framework (MOF), zeolite, and activated carbon, but aspects of the present disclosure are not limited thereto.

The porous member 285 may provide a porous space VS including a plurality of pores in the internal space GS2 of the enclosure 280. For example, the porous space VS may occupy a volume having the constant thickness T from an inner bottom of the enclosure 280 in the internal space GS2 of the enclosure 280. The porous space VS may occupy a volume being spaced apart from the rearmost surface of the supporting member 300 by the certain interval D in the internal space GS2 of the enclosure 280. In the porous space VS, an area contacting air per unit volume may increase based on a plurality of pores formed therein and a flow path of air flowing between the plurality of pores may increase, and thus, a volume of the internal space GS2 of the enclosure 280 may be greater than a real volume. Accordingly, the porous member 285 may contribute to increase a volume of internal air of the gap space GS1 between the vibration member 100 and the supporting member 300 connected or communicating with the enclosure 280. Therefore, an air impedance of the gap space GS1 between the vibration member 100 and the supporting member 300 may be reduced, and thus, a sound pressure level characteristic and/or a sound characteristic of a low-pitched sound band may be improved.

A partition member 600 providing or defining the gap space GS1 may be further provided between the vibration member 100 and the supporting member 300.

The partition member 600 may provide or define the gap space GS1 which generates a sound when the vibration member 100 is vibrated by the vibration apparatus 200. The partition member 600 may separate the sound generated by the vibration member 100, or may separate a channel, and thus, may prevent or decrease interference of the sound. The partition member 600 may be referred to as an enclosure or a baffle, but the terms are not limited thereto.

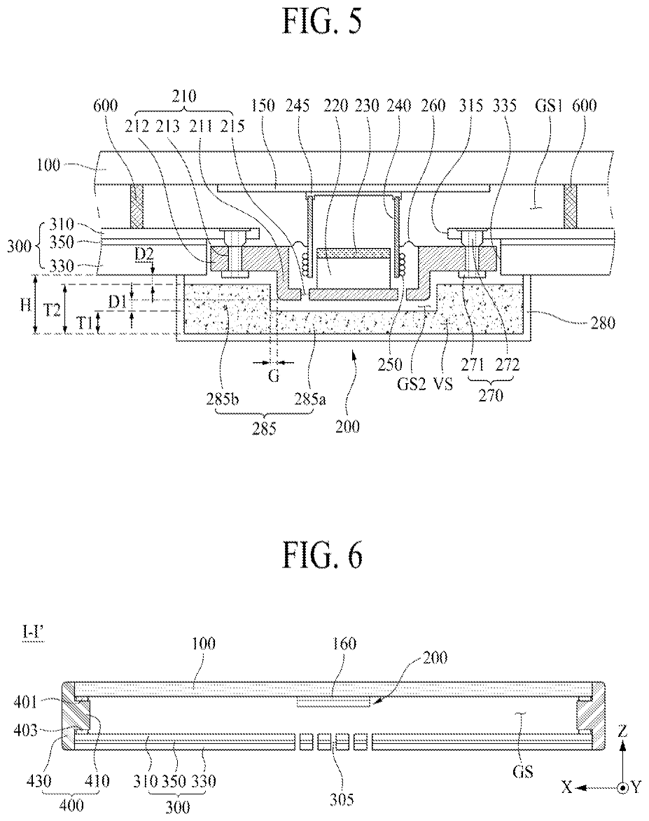

FIG. 5 illustrates a vibration apparatus according to another aspect of the present disclosure. FIG. 5 illustrates an aspect implemented by modifying a structure of the porous member illustrated in FIG. 4. Hereinafter, the vibration apparatus will be described with reference to FIG. 5, and descriptions which are the same as or similar to the descriptions of the vibration apparatus of FIG. 3 and the vibration apparatus of FIG. 4 are omitted or will be briefly given.

Referring to FIG. 5, a porous member 285 of a vibration apparatus 200 according to another aspect of the present disclosure may be configured to have different thicknesses T1 and T2 in an internal space GS2 of an enclosure 280. For example, the porous member 285 may be configured to have the different thicknesses T1 and T2 which are smaller than a height H of the internal space GS2 of the enclosure 280.

The porous member 285 may be configured to have the different thicknesses T1 and T2 capable of being spaced apart from a rear surface of the supporting member 300 by certain intervals (or distances) D1 and D2. The porous member 285 may include a first porous member 285a having a first thickness T1 and a second porous member 285b having a second thickness T2. For example, the first porous member 285a and the second porous member 285b may be provided as one body.

The first porous member 285a may be configured to have the first thickness T1 capable of being spaced apart from the rearmost surface of the supporting member 300 by a first interval D1. For example, the rear surface of the supporting member 300 may include the pure rear surface of the supporting member 300 and a rear surface of the vibration apparatus 200 coupled to the supporting member 300, and the pure rear surface of the supporting member 300 and the rear surface of the vibration apparatus 200 may have different heights. For example, the rearmost surface of the supporting member 300 may be the rear surface of the vibration apparatus 200 coupled to the supporting member 300. The rear surface of the vibration apparatus 200 may be a rear surface of a frame 210. For example, the frame 210 of the vibration apparatus 200 may include a first frame 211 and a second frame 212, and the rear surface of the first frame 211 may protrude more downward from the rear surface of the supporting member 300 than the rear surface of the second frame 212. The first porous member 285a may have the first thickness T1 capable of being spaced apart from the rear surface of the first frame 211 of the vibration apparatus 200 by the first interval D1. The first porous member 285a may have the first thickness T1 capable of being spaced apart from the rear surface of the first frame 211, where at least one air penetration hole 215 of the vibration apparatus 200 is disposed, by the first interval D1. The first porous member 285a may be provided at a portion, overlapping with the first frame 211, of the vibration apparatus 200. For example, the first porous member 285a may be provided at a portion overlapping with a range having a separation distance G from an outer surface of the first frame 211 with the first frame 211 of the vibration apparatus 200 therebetween. For example, the separation distance G from the outer surface of the first frame 211 may be equal to or different from the first interval D1 between the first porous member 285a and the rearmost surface of the supporting member 300, but aspects of the present disclosure are not limited thereto.

The second porous member 285b may be configured to have the second thickness T2 capable of being spaced apart from the rear surface of the supporting member 300 by a second interval D2. For example, the second interval D2 between the second porous member 285b and the supporting member 300 may be equal to or different from the first interval D1 between the first porous member 285a and the rearmost surface of the supporting member 300, but aspects of the present disclosure are not limited thereto. For example, the rear surface of the supporting member 300 may include the pure rear surface of the supporting member 300 and the rear surface of the vibration apparatus 200 coupled to the supporting member 300, and the pure rear surface of the supporting member 300 and the rear surface of the vibration apparatus 200 may have different heights. For example, the rear surface of the supporting member 300 may be the pure rear surface of the supporting member 300. The rear surface of the supporting member 300 may have a height which is lower than or equal to the height of the rear surface of the vibration apparatus 200 coupled to the supporting member 300 in a thickness direction of the supporting member 300. The rear surface of the supporting member 300 and the rear surface of the vibration apparatus 200 may have different heights. For example, the frame 210 of the vibration apparatus 200 may include the first frame 211 and the second frame 212, and the first frame 211 may protrude more downward from the rear surface of the supporting member 300 than the second frame 212. Also, the second frame 212 may have a height which is lower than or equal to the rear surface of the supporting member 300. For example, the second frame 212 may be fixed to a rear surface of a first supporting member 310 of the supporting member 300 and may have a height which is lower than or equal to the height of a rear surface of a second supporting member 320 of the supporting member 300 in the thickness direction of the supporting member 300. As another example, the second frame 212 may have a height which is higher than or equal to the height of the rear surface of the supporting member 300. For example, the second frame 212 may be fixed to the rear surface of the first supporting member 310 and may have a height which is higher than or equal to the height of the rear surface of the second supporting member 320 of the supporting member 300 in the thickness direction of the supporting member 300. For example, the second frame 212 may have a height which is higher than the height of the rear surface of the supporting member 300 and lower than the first frame 211, but aspects of the present disclosure are not limited thereto. The second porous member 285b may have the second thickness T2 capable of being spaced apart from the rear surface of the supporting member 300 by the second interval D2. The second porous member 285b may have the second thickness T2 capable of being spaced apart from the rear surface of the second frame 212 of the vibration apparatus 200 by the second interval D2. The second porous member 285b may be provided at a portion, which does not overlap with the first frame 211, of the vibration apparatus 200. For example, the second porous member 285b may be provided at a portion which does not overlap with a range having the separation distance G from an outer surface of the first frame 211 with the first frame 211 of the vibration apparatus 200 therebetween. For example, the separation distance G from the outer surface of the first frame 211 may be equal to or different from the second interval D2 between the second porous member 285b and the rear surface of the supporting member 300, but aspects of the present disclosure are not limited thereto.

The porous member 285 may include a porous material including a plurality of pores provided therein. The porous member 285 may include a porous material having a range where a porosity rate is about 90%. For example, the porous member 285 may include one or more materials of a porous coordination polymer (PCP), a metal organic framework (MOF), zeolite, and activated carbon, but aspects of the present disclosure are not limited thereto.

The porous member 285 may provide a porous space VS including a plurality of pores in the internal space GS2 of the enclosure 280. For example, the porous space VS may occupy a volume having the first thickness T1 and the second thickness T2 from the inner bottom of the enclosure 280 in the internal space GS2 of the enclosure 280. The porous space VS may occupy a volume which is spaced apart from the rearmost surface of the supporting member 300 by the first interval D1, is spaced apart from the rear surface of the supporting member 300 by the second interval D2, and is spaced apart from an outer sidewall of the first frame 211 of the vibration apparatus 200 by the separation distance G. The porous space VS may be provided to surround the rear surface of the supporting member 300 and the vibration apparatus 200 coupled to the supporting member 300 with being spaced apart therefrom by the certain intervals D1, D2, and G. In the porous space VS, an area contacting air per unit volume may increase based on a plurality of pores formed therein and a flow path of air flowing between the plurality of pores may increase, and thus, a volume of the internal space GS2 of the enclosure 280 may be greater than a real volume. Accordingly, the porous member 285 may contribute to increase a volume of internal air of the gap space GS1 between the vibration member 100 and the supporting member 300 connected or communicating with the enclosure 280. Therefore, an air impedance of the gap space GS1 between the vibration member 100 and the supporting member 300 may be reduced, and thus, a sound pressure level characteristic and/or a sound characteristic of a low-pitched sound band may be improved.

FIG. 6 is another cross-sectional view taken along line I-I′ illustrated in FIG. 1 according to another aspect of the present disclosure. FIG. 6 illustrates an aspect implemented by modifying a configuration of the vibration apparatus in the apparatus described above with reference to FIGS. 1 to 5. Therefore, repeated descriptions of the same elements except a configuration of a vibration apparatus and relevant elements are omitted or will be briefly given below.

Referring to FIGS. 1 and 6, an apparatus according to another aspect of the present disclosure may include a vibration member 100 and a vibration apparatus 200 disposed at a rear surface (or a backside surface) of the vibration member 100. For example, the vibration member 100 may be a passive vibration member, a vibration object, a display panel, a vibration plate, or a front member, but aspects of the present disclosure are not limited thereto. Hereinafter, an example where a vibration member is a display panel will be described.

The vibration member 100 according to an aspect of the present disclosure may be a display panel which displays an image.

According to another aspect of the present disclosure, the vibration member 100 may include one or more of metal, wood, rubber, plastic, glass, cloth, fiber, paper, mirror, and leather, but aspects of the present disclosure are not limited thereto. For example, the paper may be a cone paper for speakers. For example, the cone paper may be pulp or foam plastic, but aspects of the present disclosure are not limited thereto.

The vibration apparatus 200 according to an aspect of the present disclosure may be implemented as a film type. Because the vibration apparatus 200 is implemented as a film type, the vibration apparatus 200 may have a thickness which is thinner than the vibration member 100 or a display panel, and thus, an increase in thickness of the vibration member 100 or the display panel caused by disposition of the vibration apparatus 200 may be minimized. For example, the vibration apparatus 200 may be referred to as a sound generating module, a sound generating apparatus, a vibration generating apparatus, a displacement apparatus, a sound apparatus, a film actuator, a film type piezoelectric composite actuator, a film speaker, a film type piezoelectric speaker, or a film type piezoelectric composite speaker, which uses the vibration member 100 or the display panel as a sound vibration plate, but the terms are not limited thereto.

The vibration apparatus 200 may be disposed at a rear surface of the vibration member 100 or the display panel to overlap with a display area of the vibration member 100 or the display panel. For example, the vibration apparatus 200 may overlap with half or more of the display area of the vibration member 100 or the display panel. According to another aspect of the present disclosure, the vibration apparatus 200 may overlap with all of the display area of the vibration member 100 or the display panel.

When an alternating current (AC) voltage is applied, the vibration apparatus 200 according to an aspect of the present disclosure may alternately repeat contraction and expansion based on an inverse piezoelectric effect to vibrate and may vibrate the vibration member 100 or the display panel, based on a vibration. For example, the vibration apparatus 200 may vibrate based on a voice signal synchronized with an image displayed by the vibration member 100 or the display panel to vibrate the vibration member 100 or the display panel. According to another aspect of the present disclosure, the vibration apparatus 200 may vibrate based on a haptic feedback signal (or a tactile feedback signal) synchronized with a user touch applied to a touch panel (or a touch sensor layer) disposed in or embedded into the vibration member 100 or the display panel to vibrate the vibration member 100 or the display panel. Accordingly, the vibration member 100 or the display panel may vibrate based on a vibration of the vibration apparatus 200 to provide a user (or a viewer) with at least one of a sound and the haptic feedback.

The apparatus according to an aspect of the present disclosure may output a sound, generated by a vibration of the vibration member 100 or the display panel based on a vibration of the vibration apparatus 200, in a forward direction of the vibration member 100 or the display panel. Also, in the apparatus according to an aspect of the present disclosure, a most region of the vibration member 100 or the display panel may be vibrated by the vibration apparatus 200 of a film type, thereby more enhancing a sense of localization and a sound pressure level characteristic of a sound based on a vibration of the vibration member 100 or the display panel.

The apparatus according to an aspect of the present disclosure may further include a connection member 160 (or a first connection member) between the vibration member 100 or the display panel and the vibration apparatus 200.

For example, the connection member 160 may be disposed between a rear surface of the vibration member 100 or the display panel and the vibration apparatus 200, and thus, may connect or couple the vibration apparatus 200 to the rear surface of the vibration member 100 or the display panel. For example, the vibration apparatus 200 may be connected with or coupled to the rear surface of the vibration member 100 or the display panel by the connection member 160, and thus, may be supported by or disposed at the rear surface of the vibration member 100 or the display panel. For example, the vibration apparatus 200 may be disposed at the rear surface of the vibration member 100 or the display panel by the connection member 160.

The connection member 160 according to an aspect of the present disclosure may include a material including an adhesive layer which is good in tacky force or adhesive force, with respect to each of the vibration apparatus 200 and the rear surface of the vibration member 100 or the display panel. For example, the connection member 160 may include a foam pad, a double-sided tape, or an adhesive, but aspects of the present disclosure are not limited thereto. For example, the adhesive layer of the connection member 160 may include epoxy, acryl, silicone, or urethane, but aspects of the present disclosure are not limited thereto. For example, the adhesive layer of the connection member 160 may include an acrylic material (or substance), having a characteristic where an adhesive force is relatively better and hardness is higher, compared to urethane material. Accordingly, a vibration of the vibration apparatus 200 may be well transferred to the vibration member 100 or the display panel.

The adhesive layer of the connection member 160 may further include an additive such as a tackifier, a wax component, or an antioxidant, but aspects of the present disclosure are not limited thereto. The additive may prevent the connection member 160 from being detached (or delamination) from the vibration member 100 or the display panel by a vibration of the vibration apparatus 200. For example, the tackifier may be rosin derivatives, and the wax component may be a paraffin wax. For example, the antioxidant may be a phenolic antioxidant such as thioester, but aspects of the present disclosure are not limited thereto.

The connection member 160 according to another aspect may further include a hollow portion provided between the vibration member 100 or the display panel and the vibration apparatus 200. The hollow portion of the connection member 160 may provide an air gap between the vibration member 100 or the display panel and the vibration apparatus 200. The air gap may allow a sound wave (or a sound pressure level) based on a vibration of the vibration apparatus 200 to concentrate on the vibration member 100 or the display panel without being dispersed by the connection member 160, and thus, the loss of a vibration by the connection member 160 may be minimized, thereby increasing a sound characteristic and/or a sound pressure level characteristic of a sound generated based on a vibration of the vibration member 100 or the display panel.

The apparatus according to an aspect of the present disclosure may include a supporting member 300 which is disposed at a rear surface (or a backside surface) of the vibration member 100.

The supporting member 300 may be disposed at the rear surface of the vibration member 100 or the rear surface of the display panel. For example, the supporting member 300 may cover the rear surface of the vibration member 100 or the rear surface of the display panel. For example, the supporting member 300 may cover the whole rear surface of the vibration member 100 or the whole rear surface of the display panel with a gap space GS therebetween. The supporting member 300 may be spaced apart from a rearmost surface of the vibration member 100 or the display panel with a gap space GS therebetween, or may be spaced apart from the vibration apparatus 200. For example, the gap space GS may be referred to as an internal space, an air gap, a vibration space, or a sound sounding box, but the terms are not limited thereto.

The supporting member 300 according to an aspect of the present disclosure may include at least one through hole 305 (or a first hole). For example, the supporting member 300 may include a plurality of through holes 305.

According to an aspect of the present disclosure, the at least one through hole 305 may be provided to decrease an air pressure of a gap space GS between the vibration member 100 and the supporting member 300. For example, the at least one through hole 305 may be disposed at a position for reducing the air pressure of the gap space GS when a sound wave is generated by a vibration of the vibration apparatus 200. For example, the number, shapes, and sizes of through holes 305 may be variously set. As illustrated in FIG. 6, the at least one through hole 305 may be provided in plurality, and the plurality of through holes 305 may be arranged at a certain interval (or distance) in a region, corresponding to the vibration apparatus 200, of a region of the supporting member 300. For example, the at least one through hole 305 may be disposed in a region, corresponding to a portion of the vibration apparatus 200, of the supporting member 300. The at least one through hole 305 may be disposed in a region, corresponding to an edge (or a periphery) of the vibration apparatus 200, of the supporting member 300.

The at least one through hole 305 may provide a path which enables the gap space GS between the vibration member 100 and the supporting member 300 to be connected or communicate with the outside. The at least one through hole 305 may be formed to pass through or vertically pass through the supporting member 300 in a thickness direction Z of the supporting member 300. Accordingly, the gap space GS between the vibration member 100 and the supporting member 300 may be connected or communicate with the outside by the at least one through hole 305, and thus, the air pressure of the gap space GS between the vibration member 100 and the supporting member 300 may be reduced.

The supporting member 300 according to an aspect of the present disclosure may include a first supporting member 310 and a second supporting member 330.

The first supporting member 310 may be disposed between the rear surface of the vibration member 100 or the display panel and the second supporting member 330. For example, the first supporting member 310 may be an inner plate, a first rear structure, a first supporting structure, a first supporting cover, a first back cover, a first rear member, an internal plate, or an internal cover, but the terms are not limited thereto. According to another aspect of the present disclosure, the first supporting member 310 may be omitted.

The first supporting member 310 may be spaced apart from a rearmost surface of the vibration member 100 with a gap space GS (or a first space) therebetween, or may be spaced apart from the vibration apparatus 200. For example, the gap space GS may be referred to as a first space, an internal space, an air gap, a vibration space, or a sound sounding box, but the terms are not limited thereto.

The second supporting member 330 may be disposed at a rear surface of the first supporting member 310. For example, the second supporting member 330 may be an outer plate, a rear plate, a back plate, a back cover, a rear cover, a second rear structure, a second supporting structure, a second supporting cover, a second back cover, a second rear member, an external plate, or an external cover, but the terms are not limited thereto.

According to an aspect of the present disclosure, a first supporting member 310 and a second supporting member 330 of the supporting member 300 may each include at least one through hole 305. For example, the at least one through hole 305 may be formed to pass through or vertically pass through the first supporting member 310 and the second supporting member 330 in the thickness direction Z of the first supporting member 310 and the second supporting member 330.

According to an aspect of the present disclosure, the first supporting member 310 and the second supporting member 330 may include different materials. For example, the first supporting member 310 may include a metal material such as an aluminum (Al) material which is good in heat conductivity, and the second supporting member 330 may include a glass material, but aspects of the present disclosure are not limited thereto.

According to an aspect of the present disclosure, the first supporting member 310 and the second supporting member 330 may have the same thickness or different thicknesses. For example, the first supporting member 310 may have a thickness which is relatively thinner than the second supporting member 330, but aspects of the present disclosure are not limited thereto.

The supporting member 300 according to an aspect of the present disclosure may further include a connection member 350. For example, the connection member 350 may be disposed between the first supporting member 310 and the second supporting member 330. For example, the first supporting member 310 and the second supporting member 330 may be coupled to or connected with each other by the connection member 350.

The apparatus according to an aspect of the present disclosure may further include a middle frame 400. The middle frame 400 may provide a gap space GS between the vibration member 100 or the display panel and the supporting member 300. The middle frame 400 may be referred to as a middle cabinet, a middle cover, a middle chassis, a connection member, a frame, a frame member, a middle member, or a side cover member, but the terms are not limited thereto.

The middle frame 400 according to an aspect of the present disclosure may include a first supporting part 410 and a second supporting part 430. For example, the first supporting part 410 may be a supporting part, but the terms are not limited thereto. For example, the second supporting part 430 may be a sidewall part, but the terms are not limited thereto.

The apparatus according to an aspect of the present disclosure may further include a panel connection member (or a connection member) instead of the middle frame 400. The panel connection member may be disposed between a rear edge portion (or a rear periphery portion) of the vibration member 100 and a front edge portion (or a front periphery portion) of the supporting member 300, and thus, may provide a gap space GS between the vibration member 100 and the supporting member 300.

According to another aspect of the present disclosure, the middle frame 400 may be omitted in the apparatus according to an aspect of the present disclosure. The panel connection member or an adhesive may be provided instead of the middle frame 400. According to another aspect of the present disclosure, a partition may be provided instead of the middle frame 400.

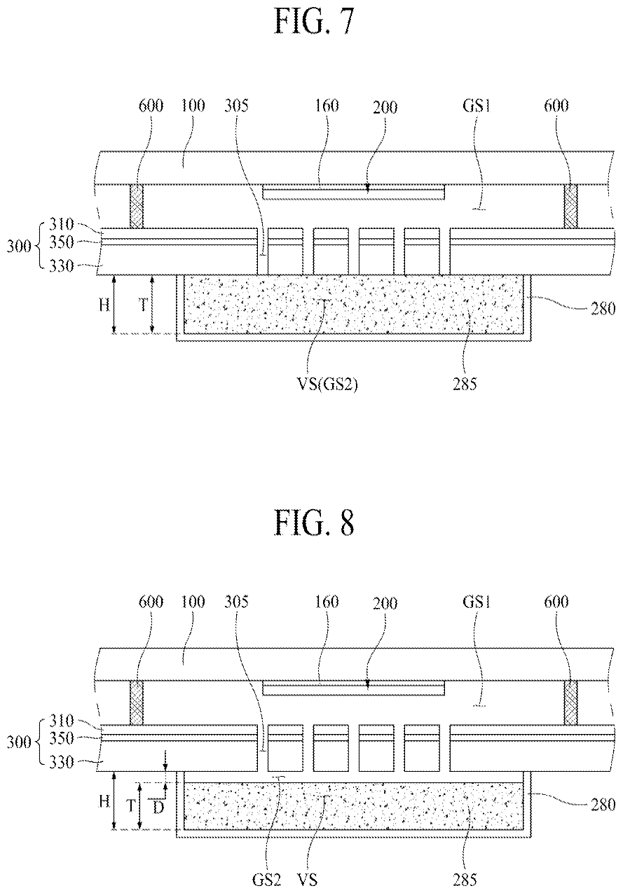

FIG. 7 illustrates a vibration apparatus according to another aspect of the present disclosure. FIG. 7 illustrates an aspect implemented by modifying a configuration of the vibration apparatus in the apparatus described above with reference to FIGS. 3 to 5. Therefore, repeated descriptions of the same elements except a configuration of a vibration apparatus and relevant elements are omitted or will be briefly given below.

Referring to FIG. 7, a vibration apparatus 200 according to another aspect of the present disclosure may be implemented as a film type where the vibration apparatus 200 is connected with or attached on a rear surface of a vibration member 100 by a connection member 160. The vibration apparatus 200 may further include an enclosure 280 which is disposed at a rear surface of the supporting member 300 to overlap with the vibration apparatus 200 and a porous member 285 between the enclosure 280 and the rear surface of the supporting member 300.

The vibration apparatus 200 may be referred to as a sound generating module, a sound generating apparatus, a vibration generating apparatus, a displacement apparatus, a sound apparatus, a film actuator, a film type piezoelectric composite actuator, a film speaker, a film type piezoelectric speaker, or a film type piezoelectric composite speaker, which uses a piezoelectric device having a piezoelectric characteristic, but the terms are not limited thereto.

The vibration apparatus 200 may be connected with or supported by the rear surface of the vibration member 100 by the connection member 160. The vibration apparatus 200 may be disposed in a gap space GS (or a first space) between the vibration member 100 and the supporting member 300 and may be surrounded by the supporting member 300, and thus, the vibration apparatus 200 may be protected from an external impact. The vibration apparatus 200 may be connected with a surface of the vibration member 100 facing the supporting member 300 to vibrate the vibration member 100.

The connection member 160 may be disposed between the vibration apparatus 200 and the vibration member 100 and may connect or couple the vibration apparatus 200 to the vibration member 100. For example, the vibration apparatus 200 may be connected with or coupled to the rear surface of the vibration member 100 by the connection member 160, and thus, may be supported by or disposed at the rear surface of the vibration member 100.

A gap space GS may be provided between the vibration member 100 and the supporting member 300. A partition member 600 providing or defining the gap space GS may be further provided between the vibration member 100 and the supporting member 300.

The partition member 600 may provide or define a gap space GS which generates a sound when the vibration member 100 is vibrated by the vibration apparatus 200. The partition member 600 may separate the sound generated by the vibration member 100, or may separate a channel, and thus, may prevent or decrease interference of the sound. The partition member 600 may be referred to as an enclosure or a baffle, but the terms are not limited thereto.

The partition member 600 may divide or provide a gap space GS corresponding to one vibration apparatus 200. For example, the partition member 600 may be provided to surround a periphery of one vibration apparatus 200. For example, the partition member 600 may surround the enclosure 280.

The gap space GS provided or divided by the partition member 600 may be connected or communicate with the outside through the at least one through hole 305 of the supporting member 300. For example, the gap space GS provided or divided by the partition member 600 may be connected or communicate with the outside through the at least one through hole 305 of the supporting member 300, and thus, an air pressure of the gap space GS may be reduced. Accordingly, because the air pressure of the gap space GS is reduced by the partition member 600, an air impedance of the gap space GS may decrease, and thus, a sound pressure level characteristic and/or a sound characteristic of a low-pitched sound band may be improved.

The enclosure 280 may be disposed at the rear surface of the supporting member 300 and may be configured to surround the at least one through hole 305 (or a first hole) of the supporting member 300. For example, the enclosure 280 may be disposed between the vibration member 100 and the supporting member 300. For example, the enclosure 280 may include an internal space GS2 (or a second space) which surrounds the rear surface of the supporting member 300. The enclosure 280 may include a box shape where one side (or one portion or an upper side or an upper portion) of the internal space GS2 is opened, but aspects of the present disclosure are not limited thereto. For example, the at least one through hole 305 (or the first hole) of the supporting member 300 may be a gap space GS1 (or a first space) between the vibration member 100 and the supporting member 300 and the internal space GS2 (or the second space) between the rear surface of the supporting member 300 and the enclosure 280. The gap space GS1 (or the first space) between the vibration member 100 and the supporting member 300 may be connected or communicate with the internal space GS2 (or the second space) between the rear surface of the supporting member 300 and the enclosure 280 through the at least one through hole 305 (or a first hole) of the supporting member 300. For example, an enclosure 280 may be a sound accommodating area, but aspects of the present disclosure are not limited thereto.

According to another aspect of the present disclosure, because the internal space GS2 (or the second space) of the enclosure 280 is connected or communicates with the gap space GS1 (or the first space) between the vibration member 100 and the supporting member 300 through the at least one through hole 305 (or the first hole) of the supporting member 300, a volume of internal air of the gap space GS1 between the vibration member 100 and the supporting member 300 may be additionally secured. For example, the internal air of the gap space GS1 between the vibration member 100 and the supporting member 300 and internal air of the internal space GS2 of the enclosure 280 may mutually flow therebetween, and thus, a volume of the internal air of the gap space GS1 between the vibration member 100 and the supporting member 300 may increase and an air resistance may be reduced. Accordingly, an air impedance of the gap space GS1 between the vibration member 100 and the supporting member 300 may decrease, and thus, a sound pressure level characteristic and/or a sound characteristic of a low-pitched sound band may be improved.

The enclosure 280 may include one or more materials of a metal material and a nonmetal material (or a complex nonmetal material), but aspects of the present disclosure are not limited thereto. For example, the enclosure 280 may include one or more materials of a metal material, plastic, and wood, but aspects of the present disclosure are not limited thereto. For example, the enclosure 280 may include a metal material based on an aluminum material, or may include plastic or a plastic material based on a styrene material, but aspects of the present disclosure are not limited thereto. For example, the styrene material may be an ABS material. The ABS material may be acrylonitrile, butadiene, and styrene.

According to another aspect of the present disclosure, the enclosure 280 may prevent sound leakage or the occurrence of a reflected sound through the through hole 305 (or the first hole) of the supporting member 300 and may prevent the penetration of particles from the outside.

The enclosure 280 may be connected with or coupled to the rear surface of the supporting member 300 by a coupling member. For example, the coupling member may be disposed between a front end of an edge (or a periphery) of the enclosure 280 and the rear surface of the supporting member 300, and the enclosure 280 may be connected with or coupled to the rear surface of the supporting member 300 by the coupling member. For example, the coupling member may be a double-sided tape, a single-sided tape, an adhesive, or a bond, but aspects of the present disclosure are not limited thereto.

The apparatus according to another aspect of the present disclosure may include a porous member 285 between the rear surface of the supporting member 300 and the enclosure 280.

The porous member 285 may be disposed between the rear surface of the supporting member 300 and the enclosure 280. The porous member 285 may be disposed on the rear surface of the supporting member 300 facing opposite to the vibration apparatus 200. For example, the porous member 285 may be contact the rear surface of the supporting member 300 facing opposite to the vibration apparatus 200. The porous member 285 may be disposed between the rear surface of the supporting member 300 and an inner surface of the enclosure 280. The porous member 285 may be disposed at the inner surface of the enclosure 280. For example, the porous member 285 may be attached on or coupled to the inner surface of the enclosure 280. The porous member 285 may be attached on or coupled to the inner surface of the enclosure 280 by an adhesive member. For example, the adhesive member may be a double-sided tape, a single-sided tape, an adhesive, or a bond, but aspects of the present disclosure are not limited thereto.

The porous member 285 according to another aspect of the present disclosure, as illustrated in FIG. 7, may be configured to have a constant thickness (or a same thickness) T in the internal space GS2 of the enclosure 280. For example, the porous member 285 may be configured to have the thickness T which is equal to a height H of the internal space GS2 of the enclosure 280. The porous member 285 may be provided to be filled in the entire internal space GS2 of the enclosure 280. The porous member 285 may be an airflow facilitating part, but aspects of the present disclosure are not limited thereto.

The porous member 285 may include a porous material including a plurality of pores provided therein. The porous member 285 may include a porous material having a range where a porosity rate is about 90%. For example, the porous member 285 may include one or more materials of a PCP, an MOF, zeolite, and activated carbon, but aspects of the present disclosure are not limited thereto. For example, a porous material may be a sound accommodating material, but aspects of the present disclosure are not limited thereto. For example, the porous member 285 and the enclosure 280 are connected or communicates through the at least one through hole 305 (or the first hole) of the supporting member 300. For example, the porous member 285 may contact the surface of the supporting member 300 facing opposite to the vibration apparatus 200.

The porous member 285 may provide a porous space VS including a plurality of pores in the internal space GS2 of the enclosure 280. For example, the porous space VS may occupy a volume which is the same as that of the internal space GS2 of the enclosure 280. In the porous space VS, an area contacting air per unit volume may increase based on a plurality of pores formed therein and a flow path of air flowing between the plurality of pores may increase, and thus, a volume of the internal space GS2 of the enclosure 280 may be greater than a real volume. Accordingly, the porous member 285 may contribute to increase a volume of internal air of the gap space GS1 between the vibration member 100 and the supporting member 300 connected or communicating with the enclosure 280. Therefore, an air impedance of the gap space GS1 between the vibration member 100 and the supporting member 300 may be reduced, and thus, a sound pressure level characteristic and/or a sound characteristic of a low-pitched sound band may be improved.

FIG. 8 illustrates a vibration apparatus according to another aspect of the present disclosure. FIG. 8 illustrates an aspect implemented by modifying a structure of the porous member illustrated in FIG. 7. Hereinafter, the vibration apparatus will be described with reference to FIG. 8, and descriptions which are the same as or similar to the descriptions of the vibration apparatus of FIG. 7 are omitted or will be briefly given.

Referring to FIG. 8, a porous member 285 of a vibration apparatus 200 according to another aspect of the present disclosure may be configured to have a constant thickness (or a same thickness) T in an internal space GS2 of an enclosure 280. For example, the porous member 285 may be configured to have the thickness T which are less than a height H of the internal space GS2 of the enclosure 280.

The porous member 285 may be spaced apart from the rear surface of the supporting member 300 by a certain interval (or distance) D and may be configured to have the constant thickness T. For example, the porous member 285 may be spaced apart from the surface of the supporting member 300 facing opposite to the vibration apparatus 200. The porous member 285 may be configured to have the constant thickness T capable of being spaced apart from the through hole 305 of the supporting member 300 by the certain interval D. For example, the porous member 285 may have the constant thickness T capable of being spaced apart from the rear surface of the supporting member 300, where the through hole 305 of the supporting member 300 is disposed, by the certain interval D.

The porous member 285 may include a porous material including a plurality of pores provided therein. The porous member 285 may include a porous material having a range where a porosity rate is about 90%. For example, the porous member 285 may include one or more materials of a PCP, an MOF, zeolite, and activated carbon, but aspects of the present disclosure are not limited thereto. For example, a porous material may be a sound accommodating material, but aspects of the present disclosure are not limited thereto. For example, the porous member 285 and the enclosure 280 are connected or communicates through the at least one through hole 305 (or the first hole) of the supporting member 300.

The porous member 285 may provide a porous space VS including a plurality of pores in the internal space GS2 of the enclosure 280. For example, the porous space VS may occupy a volume having the constant thickness T from an inner bottom of the enclosure 280 in the internal space GS2 of the enclosure 280. The porous space VS may occupy a volume which is spaced apart from the rear surface of the supporting member 300 by the certain interval D in the internal space GS2 of the enclosure 280. In the porous space VS, an area contacting air per unit volume may increase based on a plurality of pores formed therein and a flow path of air flowing between the plurality of pores may increase, and thus, a volume of the internal space GS2 of the enclosure 280 may be greater than a real volume. Accordingly, the porous member 285 may contribute to increase a volume of internal air of the gap space GS1 between the vibration member 100 and the supporting member 300 connected or communicating with the enclosure 280. Therefore, an air impedance of the gap space GS1 between the vibration member 100 and the supporting member 300 may be reduced, and thus, a sound pressure level characteristic and/or a sound characteristic of a low-pitched sound band may be improved.

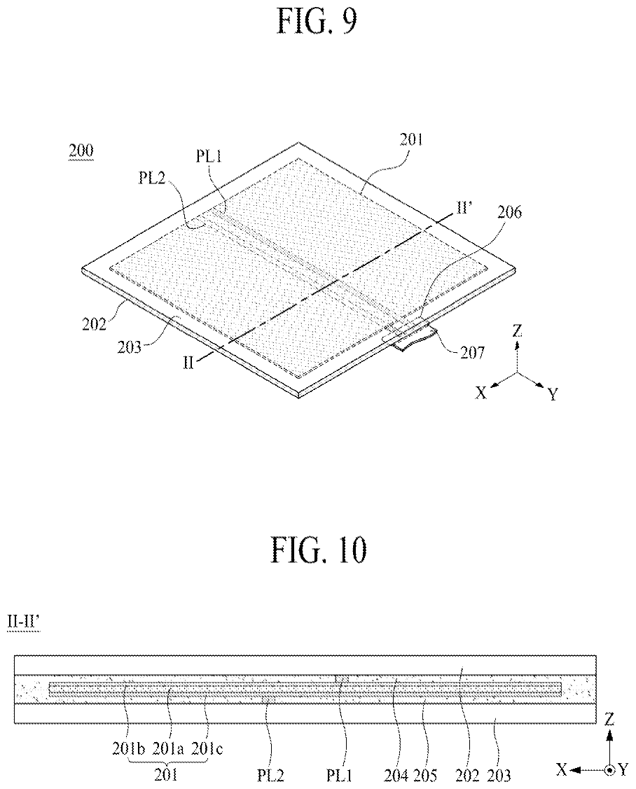

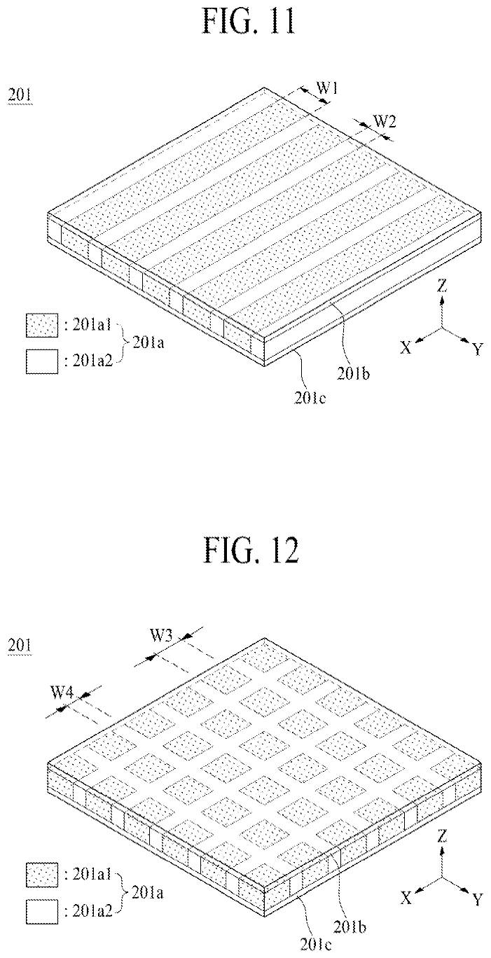

FIG. 9 illustrates a vibration apparatus according to another aspect of the present disclosure. FIG. 10 is a cross-sectional view taken along line II-IF illustrated in FIG. 9 according to another aspect of the present disclosure. FIG. 11 illustrates a vibration part illustrated in FIG. 9 according to another aspect of the present disclosure. FIGS. 9 to 11 illustrate the vibration apparatus described above with reference to FIGS. 6 to 8.

Referring to FIGS. 9 to 11, a vibration apparatus 200 according to another aspect of the present disclosure may be referred to as an active vibration member, a vibration apparatus, a flexible vibration apparatus, a flexible vibration structure, a flexible vibrator, a flexible vibration generating device, a flexible vibration generator, a flexible sounder, a flexible sound device, a flexible sound generating device, a flexible sound generator, a flexible actuator, a flexible speaker, a flexible piezoelectric speaker, a film actuator, a film type piezoelectric composite actuator, a film speaker, a film type piezoelectric speaker, or a film type piezoelectric composite speaker, but aspects of the present disclosure are not limited thereto.

The vibration apparatus 200 according to another aspect of the present disclosure may include a vibration part 201. For example, the vibration part 201 may be a piezoelectric vibration part or a piezoelectric type vibration portion. The vibration part 201 may include a vibration layer 201a, a first electrode layer 201b, and a second electrode layer 201c.

The vibration layer 201a may include a piezoelectric material (or an electroactive material) having a piezoelectric effect. For example, the piezoelectric material may have a characteristic where pressure or twisting is applied to a crystalline structure by an external force, a potential difference occurs due to dielectric polarization (or poling) caused by a relative position change of a positive (+) ion and a negative (−) ion, and a vibration is generated by an electric field based on a voltage applied thereto. The vibration layer 201a may be referred to as the terms such as a piezoelectric layer, a piezoelectric material layer, an electroactive layer, a vibration portion, a piezoelectric material portion, an electroactive portion, a piezoelectric structure, a piezoelectric composite layer, a piezoelectric composite, or a piezoelectric ceramic composite, but the terms are not limited thereto. The vibration layer 201a may include a transparent conductive material, a semitransparent conductive material, or an opaque conductive material and the vibration layer 201a may be transparent, semitransparent, or opaque.

The vibration part 201 according to an aspect of the present disclosure may include a plurality of inorganic material portions and an organic material portion between the plurality of inorganic material portions. For example, the plurality of inorganic material portions may have a piezoelectric characteristic. For example, the plurality of inorganic material portions may be a first portion 201a1, and the organic material portion may be a second portion 201a2. For example, the vibration layer 201a may include a plurality of first portions 201a1 and a plurality of second portions 201a2. For example, the plurality of first portions 201a1 and the plurality of second portions 201a2 may be alternately arranged in a first direction X (or a second direction Y). For example, the first direction X may be a horizontal direction of the vibration layer 201a and the second direction Y may be a vertical direction of the vibration layer 201a intersecting with the first direction X, but aspects of the present disclosure are not limited thereto and the first direction X may be a vertical direction of the vibration layer 201a and the second direction Y may be a horizontal direction of the vibration layer 201a.

Each of the plurality of first portions 201a1 may include an inorganic material portion. The inorganic material portion may include a piezoelectric material, a composite piezoelectric material, or an electroactive material, which has a piezoelectric effect, but aspects of the present disclosure are not limited thereto.

Each of the plurality of first portions 201a1 may include a ceramic-based material for generating a relatively strong vibration, or may include a piezoelectric ceramic having a perovskite-based crystalline structure. The perovskite crystalline structure may have a piezoelectric effect and/or an inverse piezoelectric effect, and may be a plate-shaped structure having orientation. The perovskite crystalline structure may be represented by a chemical formula “ABO₃”. In the chemical formula, “A” may include a divalent metal element, and “B” may include a tetravalent metal element. For example, in the chemical formula “ABO₃”, “A” and “B” may be cations, and “O” may be anions. For example, the first portions 201a1 may include one or more of lead(II) titanate (PbTiO₃), lead zirconate (PbZrO₃), lead zirconate titanate (PbZrTiO₃), barium titanate (BaTiO₃), and strontium titanate (SrTiO₃), but aspects of the present disclosure are not limited thereto.

In a perovskite crystalline structure, a position of a center ion may be changed by an external stress or a magnetic field to vary polarization (or poling), and a piezoelectric effect may be generated based on the variation of the polarization (or poling). In a perovskite crystalline structure including PbTiO₃, a position of a Ti ion corresponding to a center ion may be changed to vary polarization (or poling), and thus, a piezoelectric effect may be generated. For example, in the perovskite crystalline structure, a cubic shape having a symmetric structure may be changed to a tetragonal shape, an orthorhombic shape, and a rhombohedral shape each having an unsymmetric structure by an external stress or a magnetic field, and thus, a piezoelectric effect may be generated. Polarization (or poling) may be strong at a morphotropic phase boundary (MPB) of a tetragonal structure and a rhombohedral structure, and polarization (or poling) may be easily realigned, thereby obtaining a high piezoelectric characteristic.

The vibration layer 201a or the first portion 201a1 according to another aspect of the present disclosure may include one or more of lead (Pb), zirconium (Zr), titanium (Ti), zinc (Zn), nickel (Ni), and niobium (Nb), but aspects of the present disclosure are not limited thereto.

According to another aspect of the present disclosure, the vibration layer 201a or the first portion 201a1 may include a lead zirconate titanate (PZT)-based material, including lead (Pb), zirconium (Zr), and titanium (Ti); or may include a lead zirconate nickel niobate (PZNN)-based material, including lead (Pb), zirconium (Zr), nickel (Ni), and niobium (Nb), but aspects of the present disclosure are not limited thereto. According to another aspect of the present disclosure, the vibration layer 201a may include one or more of calcium titanate (CaTiO₃), BaTiO₃, and SrTiO₃, without Pb, but aspects of the present disclosure are not limited thereto.

Each of the plurality of first portions 201a1 according to an aspect of the present disclosure may be disposed between two adjacent second portions 201a2 of the plurality of second portions 201a2, and moreover, may have a first width W1 parallel to the first direction X (or the second direction Y) and may have a length parallel to the second direction Y (or the first direction X). Each of the plurality of second portions 201a2 may have a second width W2 parallel to the first direction X (or the second direction Y) and may have a length parallel to the second direction Y (or the first direction X). The first width W1 may be the same as or different from the second width W2. For example, the first width W1 may be greater than the second width W2. For example, the first portion 201a1 and the second portion 201a2 may include a line shape or a stripe shape having the same size or different sizes. Accordingly, the vibration layer 201a may have a 2-2 composite structure having a piezoelectric characteristic of a 2-2 vibration mode, and thus, may have a resonance frequency of 20 kHz or less, but aspects of the present disclosure are not limited thereto. For example, the resonance frequency of the vibration layer 201a may vary based on one or more of a shape, a length, and a thickness.

In the vibration layer 201a, the plurality of first portions 201a1 and the plurality of second portions 201a2 may be disposed (or arranged) in parallel on the same plane (or the same layer). Each of the plurality of second portions 201a2 may be configured to fill a gap between two adjacent first portions 201a1, and thus, each of the plurality of second portions 201a2 may be connected to or attached on an adjacent first portion 201a1. Accordingly, the vibration layer 201a may extend by a desired size or length on the basis of lateral coupling (or connection) of the first portion 201a1 and the second portion 201a2.

In the vibration layer 201a, the width W2 of each of the plurality of second portions 201a2 may decrease progressively in a direction from a center portion of the vibration layer 201a or the vibration apparatus 200 to both edge portions (or both ends or both periphery portions) thereof.

According to an aspect of the present disclosure, when the vibration layer 201a or the vibration apparatus 200 vibrates in an upward and downward direction Z (or a thickness direction), a second portion 201a2 having a largest width W2 among the plurality of second portions 201a2 may be disposed at a portion on which a largest stress concentrates. When the vibration layer 201a or the vibration apparatus 200 vibrates in the upward and downward direction Z, a second portion 201a2 having a smallest width W2 among the plurality of second portions 201a2 may be disposed at a portion where a relatively smallest stress occurs. For example, the second portion 201a2 having the largest width W2 among the plurality of second portions 201a2 may be disposed at a center portion of the vibration layer 201a, and the second portion 201a2 having the smallest width W2 among the plurality of second portions 201a2 may be disposed at both edge portions (or both periphery portions) of the vibration layer 201a. Accordingly, when the vibration layer 201a or the vibration apparatus 200 vibrates in the upward and downward direction Z, an overlap of a resonance frequency or interference of a sound wave generated in a portion on which a largest stress concentrates may be minimized, and thus, the dip of a sound pressure level generated in a low-pitched sound band may decrease and the flatness of a sound characteristic of the low-pitched sound band may be improved. For example, the flatness of a sound characteristic may be a magnitude of a deviation between a highest sound pressure level and a lowest sound pressure level.

In the vibration layer 201a, the plurality of first portions 201a1 may have different sizes (or widths). For example, a size (or a width) of each of the plurality of first portions 201a1 may decrease or increase progressively in a direction from the center portion of the vibration layer 201a or the vibration apparatus 200 to both edge portions (or both ends or both periphery portions) thereof. Therefore, a sound pressure level characteristic of a sound of the vibration layer 201a may be enhanced by various unique vibration frequencies based on vibrations of the plurality of first portions 201a1 having different sizes, and a reproduction band of a sound may extend.

Each of the plurality of second portions 201a2 may be disposed between the plurality of first portions 201a1. Therefore, in the vibration layer 201a or the vibration apparatus 200, vibration energy based on a link in a unit lattice of the first portion 201a1 may be increased by the second portion 201a2, and thus, a vibration characteristic may increase and a piezoelectric characteristic and flexibility may be secured. For example, the second portion 201a2 may include one of an epoxy-based polymer, an acrylic-based polymer, and a silicone-based polymer, but aspects of the present disclosure are not limited thereto.

Each of the plurality of second portions 201a2 according to an aspect of the present disclosure may include an organic material portion. For example, each of the organic material portions may be disposed between two adjacent inorganic material portions of the plurality of inorganic material portions, and thus, may absorb an impact applied to a corresponding inorganic material portion (or a first portion), a stress concentrating on the inorganic material portion may be released to enhance the durability of the vibration layer 201a or the vibration apparatus 200, and flexibility may be provided to the vibration layer 201a or the vibration apparatus 200. Accordingly, the vibration apparatus 200 may be configured to have flexibility.

The second portion 201a2 according to an aspect may have modulus (or young's modulus) and viscoelasticity which are lower than those of the first portion 201a1, and thus, may enhance the reliability of the first portion 201a1 which is vulnerable to an impact due to a fragile characteristic thereof. For example, the second portion 201a2 may include a material which has a loss coefficient of 0.01 to 1 and a modulus of 0.1 Gpa to 10 Gpa (Gigapascal).

The organic material portion included in the second portion 201a2 may include an organic material, an organic polymer, an organic piezoelectric material, or an organic non-piezoelectric material having a flexible characteristic compared to the inorganic material portion which is the first portion 201a1. For example, the second portion 201a2 may be referred to as an adhesive portion, a flexible portion, a bending portion, a damping portion, or a ductile portion, or the like, but aspects of the present disclosure are not limited thereto.

The plurality of first portions 201a1 and the plurality of second portions 201a2 may be disposed on (or connected to) the same plane, and thus, the vibration layer 201a according to an aspect of the present aspect may have a single thin film form. For example, the vibration layer 201a may have a structure where the plurality of first portions 201a1 are connected to one side thereof. For example, the vibration layer 201a may have a structure where the plurality of first portions 201a1 are connected in all of the vibration layer 201a. For example, the vibration layer 201a may be vibrated in a vertical direction by the first portion 201a1 having a vibration characteristic and may be bent in a curved shape by the second portion 201a2 having flexibility. Also, in the vibration layer 201a according to an aspect of the present disclosure, a size of the first portion 201a1 and a size of the second portion 201a2 may be adjusted based on a piezoelectric characteristic and flexibility needed for the vibration layer 201a or the vibration apparatus 200. For example, in the vibration layer 201a requiring a piezoelectric characteristic rather than flexibility, a size of the first portion 201a1 may be adjusted to be greater than that of the second portion 201a2. In another aspect of the present disclosure, in the vibration layer 201a requiring flexibility rather than a piezoelectric characteristic, a size of the second portion 201a2 may be adjusted to be greater than that of the first portion 201a1. Accordingly, a size of the vibration layer 201a may be adjusted based on a desired characteristic, and thus, the vibration layer 201a may be easily designed.

The first electrode layer 201b may be disposed on a first surface (or an upper surface) of the vibration layer 201a. The first electrode layer 201b may be disposed at or coupled (or connected) to a first surface of each of the plurality of first portions 201a1 and a first surface of each of the plurality of second portions 201a2 in common and may be electrically connected with the first surface of each of the plurality of first portions 201a1. For example, the first electrode layer 201b may have a single electrode (or one electrode) shape disposed at the whole first surface of the vibration layer 201a. For example, the first electrode layer 201b may have substantially the same shape as that of the vibration layer 201a, but aspects of the present disclosure are not limited thereto.

The second electrode layer 201c may be disposed on a second surface (or a rear surface), which is different from (or opposite to) the first surface, of the vibration layer 201a. The second electrode layer 201c may be disposed at or coupled (or connected) to a second surface of each of the plurality of first portions 201a1 and a second surface of each of the plurality of second portions 201a2 in common and may be electrically connected with the second surface of each of the plurality of first portions 201a1. For example, the second electrode layer 201c may have a single electrode (or one electrode) shape disposed at the whole second surface of the vibration layer 201a. For example, the second electrode layer 201c may have substantially the same shape as that of the vibration layer 201a, but aspects of the present disclosure are not limited thereto.

One or more of the first electrode layer 201b and the second electrode layer 201c according to an aspect of the present disclosure may include a transparent conductive material, a semitransparent conductive material, or an opaque conductive material. For example, the transparent conductive material or the semitransparent conductive material may include indium tin oxide (ITO) or indium zinc oxide (IZO), but aspects of the present disclosure are not limited thereto. Examples of the opaque conductive material may include aluminum (Al), copper (Cu), gold (Au), silver (Ag), molybdenum (Mo), and Mg or an alloy thereof, but aspects of the present disclosure are not limited thereto.

The vibration layer 201a may be polarized by a certain voltage applied to the first electrode layer 201b and the second electrode layer 201c in a certain temperature atmosphere or a temperature atmosphere which is changed from a high temperature to a room temperature, but aspects of the present disclosure are not limited thereto. For example, the vibration layer 201a may alternately repeat contraction and/or expansion according to an inverse piezoelectric effect based on a sound signal (or a voice signal or a driving signal) applied from the outside to the first electrode layer 201b and the second electrode layer 201c, and thus, may vibrate. For example, the vibration layer 201a may vibrate based on a vertical-direction vibration and a horizontal-direction vibration, based on the sound signal applied to the first electrode layer 201b and the second electrode layer 201c. The vibration layer 201a may increase a displacement of a vibration member, based on contraction and/or expansion in a horizontal direction, thereby more enhancing a vibration of the vibration member.

The vibration apparatus 200 according to an aspect of the present disclosure may further include a first cover member 202 and a second cover member 203.

The first cover member 202 may be disposed on a first surface of the vibration part 201. For example, the first cover member 202 may be configured to cover the first electrode layer 201b. Accordingly, the first cover member 202 may protect the first electrode layer 201b.

The second cover member 203 may be disposed on a second surface of the vibration part 201. For example, the second cover member 203 may be configured to cover the second electrode layer 201c. Accordingly, the second cover member 203 may protect the second electrode layer 201c.

Each of the first cover member 202 and the second cover member 203 according to an aspect of the present disclosure may include one or more materials of plastic, fiber, and wood, but aspects of the present disclosure are not limited thereto. For example, the first cover member 202 and the second cover member 203 may include the same material or different materials. For example, the first cover member 202 and the second cover member 203 may be a polyimide film or a polyethylene terephthalate film, but aspects of the present disclosure are not limited thereto.

The first cover member 202 according to an aspect of the present disclosure may be connected or coupled to the first electrode layer 201b by a first adhesive layer 204. For example, the first cover member 202 may be connected or coupled to the first electrode layer 201b through a film laminating process by the first adhesive layer 204.

A second cover member 203 according to an aspect of the present disclosure may be connected with or coupled to the second electrode layer 201c by a second adhesive layer 205. For example, the second cover member 203 may be connected with or coupled to the second electrode layer 201c by a film laminating process using the second adhesive layer 205. For example, the vibration apparatus 200 may be implemented as one film by the first cover member 202 and the second cover member 203.

The first adhesive layer 204 may be disposed between the first electrode layer 201b and the first cover member 202. The second adhesive layer 205 may be disposed between the second electrode layer 201c and the second cover member 203. For example, the first adhesive layer 204 and the second adhesive layer 205 may be provided between the first cover member 202 and the second cover member 203 to surround the vibration layer 201a, the first electrode layer 201b, and the second electrode layer 201c. For example, the first adhesive layer 204 and the second adhesive layer 205 may be provided between the first cover member 202 and the second cover member 203 to fully surround the vibration layer 201a, the first electrode layer 201b, and the second electrode layer 201c. For example, the vibration layer 201a, the first electrode layer 201b, and the second electrode layer 201c may be buried or embedded between the first adhesive layer 204 and the second adhesive layer 205.

Each of the first adhesive layer 204 and the second adhesive layer 205 according to an aspect of the present disclosure may include an electrical insulation material which has adhesive properties and is capable of compression and decompression. For example, each of the first adhesive layer 204 and the second adhesive layer 205 may include epoxy resin, acrylic resin, silicone resin, and urethane resin, but aspects of the present disclosure are not limited thereto.

The vibration apparatus 200 according to an aspect of the present disclosure may further include a first power supply line PL1 which is disposed in the first cover member 202, a second power supply line PL2 which is disposed in the second cover member 203, and a pad part 206 which is electrically connected to the first power supply line PL1 and the second power supply line PL2.

The first power supply line PL1 may be disposed between the first electrode layer 201b and the first cover member 202 and may be electrically connected to the first electrode layer 201b. The first power supply line PL1 may extend long in a second direction Y and may be electrically connected to a center portion of the first electrode layer 201b. In an aspect, the first power supply line PL1 may be electrically connected to the first electrode layer 201b by an anisotropic conductive film. In another aspect, the first power supply line PL1 may be electrically connected to the first electrode layer 201b through a conductive material (or particles) included in the first adhesive layer 204.

The second power supply line PL2 may be disposed between the second electrode layer 201c and the second cover member 203 and may be electrically connected to the second electrode layer 201c. The second power supply line PL2 may extend long in the second direction Y and may be electrically connected to a center portion of the second electrode layer 201c. In an aspect, the second power supply line PL2 may be electrically connected to the second electrode layer 201c by an anisotropic conductive film. In another aspect, the second power supply line PL2 may be electrically connected to the second electrode layer 201c through a conductive material (or particles) included in the second adhesive layer 205.

According to an aspect of the present disclosure, a first power supply line PL1 and a second power supply line PL2 may be disposed not to overlap with each other. When the first power supply line PL1 is disposed not to overlap with the second power supply line PL2, a problem of a short circuit defect between the first power supply line PL1 and the second power supply line PL2 may be solved.

The pad part 206 may be provided at one edge portion (or one periphery portion) of one of the first cover member 202 and the second cover member 203 to be electrically connected to one side (or one end or one portion) of each of the first power supply line PL1 and the second power supply line PL2.

The pad part 206 according to an aspect of the present disclosure may include a first pad electrode which is electrically connected to one end of the first power supply line PL1 and a second pad electrode which is electrically connected to one end of the second power supply line PL2.

The first pad electrode may be disposed at one edge portion (or one periphery portion) of one of the first cover member 202 and the second cover member 203 and may be connected to one end of the first power supply line PL1. For example, the first pad electrode may pass through one of the first cover member 202 and the second cover member 203 and may be electrically connected to one end of the first power supply line PL1.

The second pad electrode may be disposed in parallel with the first pad electrode and may be connected to one end of the second power supply line PL2. For example, the second pad electrode may pass through one of the first cover member 202 and the second cover member 203 and may be electrically connected to one end of the second power supply line PL2.

According to an aspect of the present disclosure, each of the first power supply line PL1, the second power supply line PL2, and the pad part 206 may be configured to be transparent, semitransparent, or opaque.

A pad part 206 according to an aspect of the present disclosure may be electrically connected with a signal cable 207.

The signal cable 207 may be electrically connected with the pad part 206 disposed in the vibration apparatus 200 and may supply the vibration apparatus 200 with a vibration driving signal (or a sound signal or a voice signal) provided from a sound processing circuit. The signal cable 207 according to an aspect of the present disclosure may include a first terminal electrically connected with a first pad electrode of the pad part 206 and a second terminal electrically connected with a second pad electrode of the pad part 206. For example, the signal cable 207 may be configured as a flexible printed circuit cable, a flexible flat cable, a single-sided flexible printed circuit, a single-sided flexible printed circuit board (PCB), a flexible multi-layer printed circuit, or a flexible multi-layer PCB, but aspects of the present disclosure are not limited thereto.

The sound processing circuit may generate an alternating current (AC) vibration driving signal including a first vibration driving signal and a second vibration driving signal on the basis of sound data provided from an external sound data generating circuit. The first vibration driving signal may be one of a positive (+) vibration driving signal and a negative (−) vibration driving signal, and the second vibration driving signal may be one of the positive (+) vibration driving signal and the negative (−) vibration driving signal. For example, the first vibration driving signal may be supplied to the first electrode layer 201b through or by the first terminal of the signal cable 207, the first pad electrode of the pad part 206, and the first power supply line PL1. The second vibration driving signal may be supplied to the second electrode layer 201c through or by the second terminal of the signal cable 207, the second pad electrode of the pad part 206, and the second power supply line PL2.

According to an aspect, the signal cable 207 may be configured to be transparent, semitransparent, or opaque.

The vibration apparatus 200 according to an aspect of the present disclosure may be implemented as a thin film as the first portion 201a1 having a piezoelectric characteristic and the second portion 201a2 having flexibility are alternately and repeatedly connected with each other. Therefore, a vibration width (or a displacement width) of the vibration apparatus 200 may increase based on the second portion 201a2 having flexibility. Accordingly, a sound characteristic and/or a sound pressure level characteristic of a low-pitched sound band generated based on a vibration of the vibration member may be enhanced.

FIGS. 12 to 14 illustrate another aspect of the vibration part illustrated in FIG. 11 according to another aspect of the present disclosure.

With reference to FIG. 12, a vibration layer 201a of a vibration part 201 according to another aspect of the present disclosure may include a plurality of first portions 201a1, which are spaced apart from one another in a first direction X and a second direction Y, and a second portion 201a2 disposed between the plurality of first portions 201a1.

The plurality of first portions 201a1 may be arranged apart from one another in each of the first direction X and the second direction Y. For example, the plurality of first portions 201a1 may be arranged in a lattice form to have a hexahedral shape having the same size. Each of the plurality of first portions 201a1 may include substantially the same piezoelectric material as that of the first portion 201a1 described above with reference to FIGS. 9 to 11, and thus, like reference numerals refer to like elements and repeated descriptions thereof are omitted.

The second portion 201a2 may be arranged between the plurality of first portions 201a1 in each of the first direction X and the second direction Y. The second portion 201a2 may be configured to fill a gap between two adjacent first portions 201a1 or surround each of the plurality of first portions 201a1, and thus, may be connected or adhered to an adjacent first portion 201a1. According to an aspect of the present disclosure, a width W4 of the second portion 201a2 disposed between two first portions 201a1 adjacent to each other in the first direction X may be the same as or different from that the width W3 of the first portion 201a1, and a width of the second portion 201a2 disposed between two first portions 201a1 adjacent to each other in the second direction Y may be the same as or different from that of the first portion 201a1. The second portion 201a2 may include substantially the same piezoelectric material as that of the second portion 201a2 described above with reference to FIGS. 9 to 11, and thus, like reference numerals refer to like elements and repeated descriptions thereof are omitted.

The vibration layer 201a according to another aspect of the present disclosure may have a 1-3 composite structure having a piezoelectric characteristic of a 1-3 vibration mode, and thus, may have a resonance frequency of 30 MHz or less, but aspects of the present disclosure are not limited thereto. For example, the resonance frequency of the vibration layer 201a may vary based on one or more of a shape, a length, and a thickness.

With reference to FIG. 13, a vibration layer 201a of a vibration part 201 according to another aspect of the present disclosure may include a plurality of first portions 201a1, which are spaced apart from one another in a first direction X and a second direction Y, and a second portion 201a2 disposed between the plurality of first portions 201a1.

Each of the plurality of first portions 201a1 may have a circular-shaped planar structure. For example, each of the plurality of first portions 201a1 may have a circular plate shape, but aspects of the present disclosure are not limited thereto. For example, each of the plurality of first portions 201a1 may have a dot shape such as an oval shape, a polygonal shape, or a donut shape. Each of the plurality of first portions 201a1 may include substantially the same piezoelectric material as that of the first portion 201a1 described above with reference to FIGS. 9 to 11, and thus, like reference numerals refer to like elements and repeated descriptions thereof are omitted.

The second portion 201a2 may be arranged between the plurality of first portions 201a1 in each of the first direction X and the second direction Y. The second portion 201a2 may be configured to surround each of the plurality of first portions 201a1, and thus, may be connected or adhered to a lateral surface of each of the plurality of first portions 201a1. Each of the plurality of first portions 201a1 and the second portion 201a2 may be disposed (or arranged) in parallel on the same plane (or the same layer). The second portion 201a2 may include substantially the same organic material as that of the second portion 201a2 described above with reference to FIGS. 9 to 11, and thus, like reference numerals refer to like elements and repeated descriptions thereof are omitted.

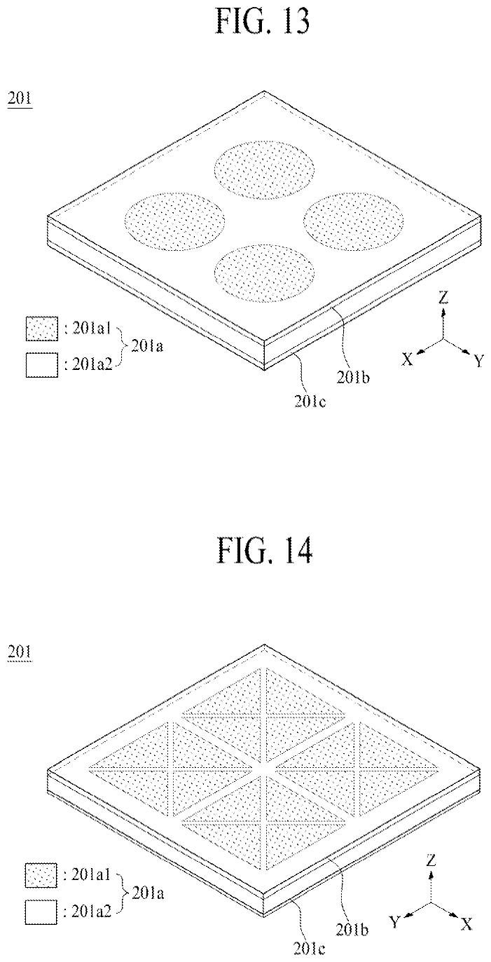

With reference to FIG. 14, a vibration layer 201a of a vibration part 201 according to another aspect of the present disclosure may include a plurality of first portions 201a1, which are spaced apart from one another in a first direction X and a second direction Y, and a second portion 201a2 disposed between the plurality of first portions 201a1.

Each of the plurality of first portions 201a1 may have a triangular-shaped planar structure. For example, each of the plurality of first portions 201a1 may have a triangular plate shape. Each of the plurality of first portions 201a1 may include substantially the same piezoelectric material as that of the first portion 201a1 described above with reference to FIGS. 9 to 11, and thus, like reference numerals refer to like elements and repeated descriptions thereof are omitted.

According to an aspect of the present disclosure, four adjacent first portions 201a1 of the plurality of first portions 201a1 may be arranged adjacent to one another to form a tetragonal shape (or a square shape). A vertex of each of the four adjacent first portions 201a1 forming a tetragonal shape may be disposed adjacent to a center portion (or a middle portion) of a tetragonal shape.

The second portion 201a2 may be arranged between the plurality of first portions 201a1 in each of the first direction X and the second direction Y. The second portion 201a2 may be configured to surround each of the plurality of first portions 201a1, and thus, may be connected or adhered to a lateral surface of each of the plurality of first portions 201a1. Each of the plurality of first portions 201a1 and the second portion 201a2 may be disposed (or arranged) in parallel on the same plane (or the same layer). The second portion 201a2 may include substantially the same organic material as that of the second portion 201a2 described above with reference to FIGS. 9 to 11, and thus, like reference numerals refer to like elements and repeated descriptions thereof are omitted.

According to another aspect of the present disclosure, 2N (where N is a natural number of 2 or more) of adjacent first portions 201a1 among a plurality of first portions 201a1 having a triangular shape may be arranged adjacent to one another to form a 2N-angular shape. For example, six adjacent first portions 201a1 among the plurality of first portions 201a1 may be arranged adjacent to one another to form a hexagonal shape (or a regular hexagon). A vertex of each of six adjacent first portions 201a1 having a hexagonal shape may be disposed adjacent to a center portion (or a regular center portion) of a hexagonal shape. The second portion 201a2 may be provided to surround each of the plurality of first portions 201a1, and thus, may be connected with or attached on a lateral surface of each of the plurality of first portions 201a1. The plurality of first portions 201a1 and the second portion 201a2 may be disposed (or arranged) in parallel on the same plane (or the same layer).

An apparatus according to an aspect of the present disclosure may be applied to or included in a vibration generating apparatus and/or a sound generating apparatus. The apparatus according to an aspect of the present disclosure may be applied to or included in mobile apparatuses, video phones, smart watches, watch phones, wearable apparatuses, foldable apparatuses, rollable apparatuses, bendable apparatuses, flexible apparatuses, curved apparatuses, sliding apparatuses, variable apparatuses, electronic organizers, e-books, portable multimedia players (PMPs), personal digital assistants (PDAs), MP3 players, mobile medical apparatuses, desktop personal computers (PCs), laptop PCs, netbook computers, workstations, navigation apparatuses, automotive navigation apparatuses, automotive display apparatuses, automotive apparatuses, cinema display apparatuses, televisions (TVs), wall paper display apparatuses, signage apparatuses, game machines, notebook computers, monitors, cameras, camcorders, home appliances, etc.

An apparatus according to various aspects of the present disclosure will be described below.

An apparatus according to various aspects of the present disclosure may include a vibration member, a vibration apparatus configured to vibrate the vibration member, a supporting member at a rear surface of the vibration member, an enclosure at a rear surface of the supporting member overlapping with the vibration apparatus, and a porous member between the rear surface of the supporting member and the enclosure.

According to various aspects of the present disclosure, the supporting member may include at least one first hole overlapping with the vibration apparatus.

According to various aspects of the present disclosure, the at least one first hole may be between a first space between the vibration member and the supporting member and a second space between the rear surface of the supporting member and the enclosure.

According to various aspects of the present disclosure, the first space may be connected with the second space by the at least one first hole.

According to various aspects of the present disclosure, the vibration apparatus may include at least one second hole accommodated into the at least one first hole of the supporting member and connected with the second space.

According to various aspects of the present disclosure, the at least one second hole may overlap with the at least one first hole.

According to various aspects of the present disclosure, the porous member may be spaced apart from the rear surface of the supporting member.

According to various aspects of the present disclosure, the porous member may have a constant thickness.

According to various aspects of the present disclosure, the vibration apparatus may include a frame connected with the supporting member and including the at least one second hole, a magnet on the frame, a bobbin around the magnet, and a coil around the bobbin.

According to various aspects of the present disclosure, the at least one second hole may overlap with the bobbin and the coil.

According to various aspects of the present disclosure, the porous member may be spaced apart from a rear surface of the frame.

According to various aspects of the present disclosure, the frame may include a first frame into which the magnet, the bobbin, and the coil are accommodated, and a second frame protruding downward from a periphery of the first frame. The second frame may be fixed to the supporting member.

According to various aspects of the present disclosure, the at least one second hole may be disposed in the first frame.

According to various aspects of the present disclosure, a rear surface of the first frame may protrude more downward from the rear surface of the supporting member than a rear surface of the second frame.

According to various aspects of the present disclosure, the porous member may be spaced apart from the rear surface of the first frame.

According to various aspects of the present disclosure, the porous member may be spaced apart from the rear surface of the second frame.

According to various aspects of the present disclosure, the porous member may have different thicknesses.

According to various aspects of the present disclosure, the vibration apparatus may be connected with the rear surface of the vibration member to vibrate the vibration member.

According to various aspects of the present disclosure, the vibration apparatus may be disposed between the vibration member and the supporting member.

According to various aspects of the present disclosure, the vibration apparatus may include a vibration layer, a first electrode layer at a first surface of the vibration layer, and a second electrode layer at a second surface different from the first surface of the vibration layer.

According to various aspects of the present disclosure, the vibration layer may include a plurality of inorganic material portions having a piezoelectric characteristic, and an organic material portion between the plurality of inorganic material portions.

According to various aspects of the present disclosure, the vibration layer may include a piezoelectric material.

According to various aspects of the present disclosure, the porous member may overlap with the at least one first hole.

According to various aspects of the present disclosure, the porous member may contact the rear surface of the supporting member.

According to various aspects of the present disclosure, the enclosure may be provided at the rear surface of the supporting member to cover the at least one second hole.

According to various aspects of the present disclosure, may further include a partition member disposed between the vibration member and the supporting member and surrounding the vibration apparatus.

According to various aspects of the present disclosure, the porous member may include one or more materials of porous coordination polymer, metal organic framework, zeolite, and activated carbon.

According to various aspects of the present disclosure, the vibration member may include one or more materials of metal, plastic, fiber, leather, wood, cloth, rubber, carbon, glass, and paper.

An apparatus according to various aspects of the present disclosure may include a vibration member, a vibration apparatus disposed on the vibration member and causing the vibration member to vibrate, a supporting member facing the vibration member, a sound accommodating area between the vibration member and the supporting member, and an airflow facilitating part including a sound accommodating material and disposed on a surface of the supporting member facing opposite to the vibration apparatus.

According to various aspects of the present disclosure, the sound accommodating area and the airflow facilitating part may be connected through at least one through hole in the supporting member.

According to various aspects of the present disclosure, the vibration apparatus may be connected with a surface of the vibration member facing the supporting member to vibrate the vibration member.

According to various aspects of the present disclosure, may further include a partition member disposed between the vibration member and the supporting member and surrounding the sound accommodating area.

According to various aspects of the present disclosure, the airflow facilitating part may contact the surface of the supporting member facing opposite to the vibration apparatus.

According to various aspects of the present disclosure, the airflow facilitating part may be spaced apart from the surface of the supporting member facing opposite to the vibration apparatus.

It will be apparent to those skilled in the art that various modifications and variations may be made in the present disclosure without departing from the scope of the disclosures. Thus, it is intended that the present disclosure covers the modifications and variations of this disclosure provided they come within the scope of the appended claims and their equivalents.

What is claimed is:

1. An apparatus, comprising:
a vibration member;
a vibration apparatus configured to vibrate the vibration member;
a supporting member disposed at a rear surface of the vibration member;
an enclosure disposed at a rear surface of the supporting member overlapping with the vibration apparatus; and
a porous member disposed between the rear surface of the supporting member and the enclosure.

2. The apparatus of claim 1, wherein the supporting member comprises at least one first hole overlapping with the vibration apparatus.

3. The apparatus of claim 2, wherein the at least one first hole is disposed between a first space between the vibration member and the supporting member and a second space disposed between the rear surface of the supporting member and the enclosure.

4. The apparatus of claim 3, wherein the first space is connected with the second space by the at least one first hole.

5. The apparatus of claim 4, wherein the vibration apparatus comprises at least one second hole accommodated into the at least one first hole of the supporting member and connected with the second space.

6. The apparatus of claim 5, wherein the at least one second hole overlaps with the at least one first hole.

7. The apparatus of claim 1, wherein the porous member is spaced apart from the rear surface of the supporting member.

8. The apparatus of claim 7, wherein the porous member has a constant thickness.

9. The apparatus of claim 5, wherein the vibration apparatus comprises:
a frame connected with the supporting member and including the at least one second hole;
a magnet disposed on the frame;
a bobbin disposed around the magnet; and
a coil disposed around the bobbin.

10. The apparatus of claim 9, wherein the at least one second hole overlaps with the bobbin and the coil.

11. The apparatus of claim 9, wherein the porous member is spaced apart from a rear surface of the frame.

12. The apparatus of claim 9, wherein the frame comprises:
a first frame into which the magnet, the bobbin, and the coil are accommodated; and
a second frame protruding downward from a periphery of the first frame,
wherein the second frame is fixed to the supporting member.

13. The apparatus of claim 12, wherein the at least one second hole is disposed in the first frame.

14. The apparatus of claim 12, wherein a rear surface of the first frame protrudes more downward from the rear surface of the supporting member than a rear surface of the second frame.

15. The apparatus of claim 14, wherein the porous member is spaced apart from the rear surface of the first frame.

16. The apparatus of claim 15, wherein the porous member is spaced apart from the rear surface of the second frame.

17. The apparatus of claim 16, wherein the porous member has different thicknesses.

18. The apparatus of claim 2, wherein the vibration apparatus is connected with the rear surface of the vibration member to vibrate the vibration member.

19. The apparatus of claim 18, wherein the vibration apparatus is disposed between the vibration member and the supporting member.

20. The apparatus of claim 18, wherein the vibration apparatus comprises:
a vibration layer;
a first electrode layer disposed at a first surface of the vibration layer; and
a second electrode layer disposed at a second surface different from the first surface of the vibration layer.

21. The apparatus of claim 20, wherein the vibration layer comprises:
a plurality of inorganic material portions having a piezoelectric characteristic; and
an organic material portion between the plurality of inorganic material portions.

22. The apparatus of claim 20, wherein the vibration layer comprises a piezoelectric material.

23. The apparatus of claim 18, wherein the porous member overlaps with the at least one first hole.

24. The apparatus of claim 18, wherein the porous member contacts the rear surface of the supporting member.

25. The apparatus of claim 5, wherein the enclosure is provided at the rear surface of the supporting member to cover the at least one second hole.

26. The apparatus of claim 1, further comprising a partition member disposed between the vibration member and the supporting member and surrounding the vibration apparatus.

27. The apparatus of claim 1, wherein the porous member comprises one or more materials of porous coordination polymer, metal organic framework, zeolite, and activated carbon.

28. The apparatus of claim 1, wherein the vibration member comprises one or more materials of metal, plastic, fiber, leather, wood, cloth, rubber, carbon, glass, and paper.

29. An apparatus, comprising:
a vibration member;
a vibration apparatus disposed on the vibration member and causing the vibration member to vibrate;
a supporting member facing the vibration member;
a sound accommodating area between the vibration member and the supporting member; and
an airflow facilitating part including a sound accommodating material and disposed at a surface of the supporting member facing opposite to the vibration apparatus.

30. The apparatus of claim 29, wherein the sound accommodating area and the airflow facilitating part are connected through at least one through hole in the supporting member.

31. The apparatus of claim 29, wherein the vibration apparatus is connected with a surface of the vibration member facing the supporting member to vibrate the vibration member.

32. The apparatus of claim 29, further comprising a partition member disposed between the vibration member and the supporting member and surrounding the sound accommodating area.

33. The apparatus of claim 29, wherein the airflow facilitating part contacts the surface of the supporting member facing opposite to the vibration apparatus.

34. The apparatus of claim 29, wherein the airflow facilitating part is spaced apart from the surface of the supporting member facing opposite to the vibration apparatus.
